(19) United States
(12) Patent Application Publication
(10) Pub. No.: US 2015/0138252 A1
(43) Pub. Date: May 21, 2015

(54) MULTISCREEN DISPLAY DEVICE

(71) Applicant: Mitsubishi Electric Corporation, Tokyo (JP)

(72) Inventors: Toshiyuki OKANO, Tokyo (JP); Yoshinori ASAMURA, Tokyo (JP)

(73) Assignee: Mitsubishi Electric Corporation, Tokyo (JP)

(21) Appl. No.: 14/491,144

(22) Filed: Sep. 19, 2014

(30) Foreign Application Priority Data
Nov. 20, 2013 (JP) 2013-239578

(51) Int. Cl. G06F 3/14; H04N 5/57; H04N 9/77; G09G 5/10

(52) U.S. Cl. CPC G06F 3/1446; G09G 5/10; H04N 5/57; H04N 9/77; G09G 2320/0626; G09G 2360/04
USPC 345/690

(57) ABSTRACT

A microcomputer calculates a target brightness per brightness mode. Each projection video image display device specifies a target control current value corresponding to a calculated target brightness corresponding to a brightness mode set to the projection video image display device. Each projection video image display device supplies a current indicating the specified control current value to a light source of the projection video image display device.

### BACKGROUND OF THE INVENTION

1. Field of the Invention

The present invention relates to a multiscreen display device formed with each projection video image display device to which one of a plurality of types of brightness modes is set.

2. Description of the Background Art

As a device which displays a video image on a large screen, there is a multiscreen display device which displays a video image on a multiscreen formed with screens of a plurality of projection video image display devices. For example, an optical device such as a high voltage discharge lamp and an LED (Light Emitting Diode) which is a semiconductor light emitting element is used for a light source of each projection video image display device which forms this multiscreen display device. A brightness varies in a video image displayed on each of a plurality of projection video image display devices due to manufacturing variations of these optical devices in some cases. When there are brightness variations, a brightness difference between screens in a multiscreen becomes distinct, and unity of a video image displayed on the entire multiscreen is lost in some cases.

Hence, Japanese Patent No. 3703361 discloses a technique (also referred to as related art A) of suppressing a brightness variation of each screen in a multiscreen (screen). More specifically, according to the related art A, each projection video image display device occasionally measures a brightness of a light used to form a video image. Further, the measured brightness is shared between a plurality of projection video image display devices. Furthermore, for example, the minimum brightness of a plurality of measured brightnesses is set as a target brightness. Next, each projection video image display device sets a current value which makes a brightness of a video image displayed by the projection video image display device a target brightness using a relationship between a brightness value and a value of a current which flows in the light source. Consequently, each projection video image display device makes brightnesses of video images to be displayed uniform.

Further, Japanese Patent Application Laid-Open No. 2012-150149 also discloses a technique of suppressing brightness variations similar to Japanese Patent No. 3703361.

However, there are many cases where a multiscreen display device formed with a plurality of projection video image display devices is mainly used in monitoring rooms for roads, the traffic and plants. In the cases, output brightnesses of all projection video image display devices which form a multiscreen display device do not need to be maximized at all times depending on time zones and display content.

Each projection video image display device which forms the multiscreen display device generally includes a plurality of types of brightness modes of displaying video images at different brightnesses. Therefore, in the multiscreen display device, a brightness mode whose video image brightness is lower than those of brightness modes of other projection video image display devices is set to a specific projection video image display device to suppress power consumption.

In addition, when the number of specific projection video image display devices to which the same brightness mode is set is plural, it is necessary to suppress brightness variations between screens of the projection video image display devices to which the same brightness mode is set. A light source suitable to the brightness mode set to each projection video image display device needs to be controlled to suppress brightness variations. In this regard, the related art A cannot control a light source suitable to a brightness mode.

### SUMMARY OF THE INVENTION

It is therefore an object of the present invention to provide a multiscreen display device which can control a light source suitable to a brightness mode.

A multiscreen display device according to one aspect of the present invention displays a video image on a multiscreen formed with screens of a plurality of projection video image display devices which communicate with each other. Each of the plurality of projection video image display devices includes a light source which emits a light of a brightness corresponding to a current to be supplied, and is formed with a semiconductor light emitting element, one of a plurality of types of brightness modes of different video image brightnesses which are brightnesses of video images to be displayed by the projection video image display device using a light emitted from the light source is set to each of the projection video image display devices, each of a plurality of projection video image display devices further includes a storage unit which stores brightness characteristics which are characteristics indicating a relationship between a control current of the light source and the video image brightness as a brightness corresponding to the control current, a first projection video image display device which is one of a plurality of projection video image display devices includes a calculating unit which calculates a target brightness which is a brightness of a target for each of the brightness mode, based on the video image brightness which the first projection video image display device can output and the video image brightness which a second projection video image display device other than the first projection video image display device of a plurality of projection video image display devices can output, and each of the projection video display devices (a) specifies a control current value which is a value of the control current corresponding to the target brightness calculated according to the brightness mode set to the projection video image display device using the brightness characteristics, and which is a target, and (b) supplies a current indicating the specified control current value, to the light source of the projection video image display device.

According to the present invention, the calculating unit calculates a target brightness for each brightness mode. Each of the projection video image display devices specifies a target control current value corresponding to the target brightness calculated according to the brightness mode set to the projection video image display device. Each of the projection video image display devices supplies a current indicating the specified control current value, to the light source of the projection video image display device.

Consequently, it is possible to control a light source suitable to the brightness mode. Consequently, it is possible to suppress a brightness variation of each projection video image display device to which the same brightness mode is set.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view illustrating a configuration of a multiscreen display device according to a first preferred embodiment of the present invention;

FIG. 2 is a view for explaining a multiscreen;

FIG. 3 is a block diagram illustrating a configuration of a projection video image display device according to the first preferred embodiment of the present invention;

FIG. 4 is a view illustrating an example of brightness characteristics;

FIG. 5 is a flowchart of brightness adjustment processing;

FIG. 6 is a view illustrating a state of a brightness mode set to each projection video image display device;

FIG. 7 is a view illustrating an example of chromaticity characteristics;

FIG. 8 is a flowchart of brightness/chromaticity adjustment processing;

FIG. 9 is a view for explaining a method of calculating a target chromaticity;

FIG. 10 is a view illustrating characteristic brightness which each projection video image display device can output;

FIG. 11 is a view illustrating a transition of a target brightness when a brightness mode is changed in a comparative example;

FIG. 12 is a flowchart of target brightness calculation processing A1; and

FIG. 13 is a view for explaining target brightness calculation processing according to a third preferred embodiment of the present invention.

### DESCRIPTION OF THE PREFERRED EMBODIMENTS

Preferred embodiments of the present invention will be described below with reference to the drawings. The same components will be assigned the same reference numerals in the following description. Names and functions of these components are the same. Hence, these components will not be described in detail in some cases.

### First Preferred Embodiment

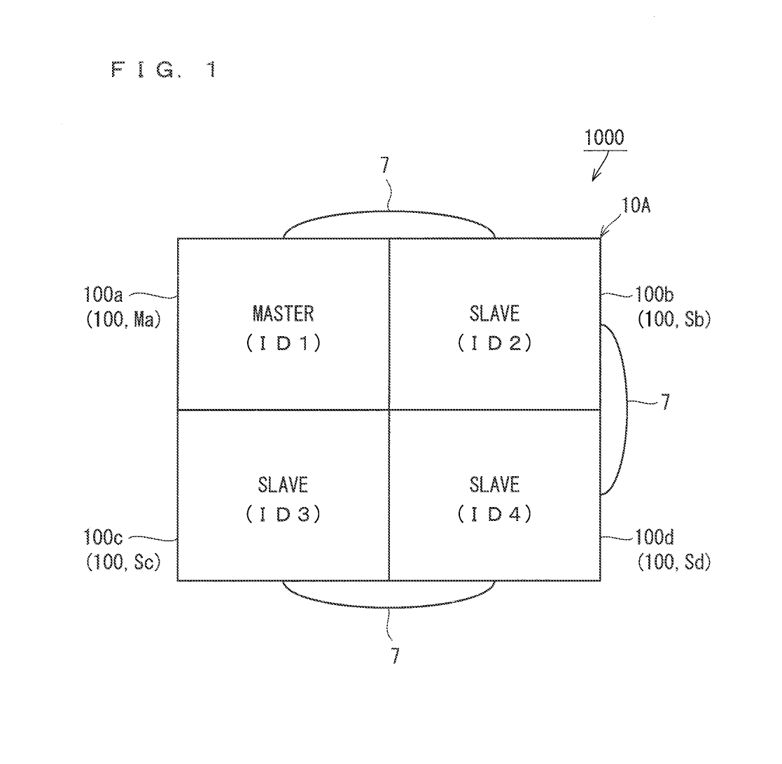

FIG. 1 is a view illustrating a configuration of a multiscreen display device 1000 according to a first preferred embodiment of the present invention. Although described in detail below, the multiscreen display device 1000 is formed with a plurality of projection video image display devices which can project video image lights which configure video images, on a screen. Further, the multiscreen display device 1000 is a device which displays a video image on a multiscreen which is formed with screens of a plurality of projection video image display devices which communicate with each other. The multiscreen display device 1000 will be more specifically described below.

As illustrated in FIG. 1, the multiscreen display device 1000 includes projection video image display devices 100a, 100b, 100c and 100d. Although described below in detail, each of the projection video image display devices 100a, 100b, 100c and 100d employs the same configuration. Each of the projection video image display devices 100a, 100b, 100c and 100d is also described simply as a projection video image display device 100 below. That is, the multiscreen display device 1000 is formed with the four projection video image display devices 100.

In addition, the number of the projection video image display devices 100 which form the multiscreen display device 1000 is not limited to four, and may be two, three, five or more.

Each projection video image display device 100 includes a plurality of types of brightness modes for changing a brightness of a video image. One of a plurality of types of brightness modes is set to each projection video image display device 100. In addition, brightness modes will be described in detail below.

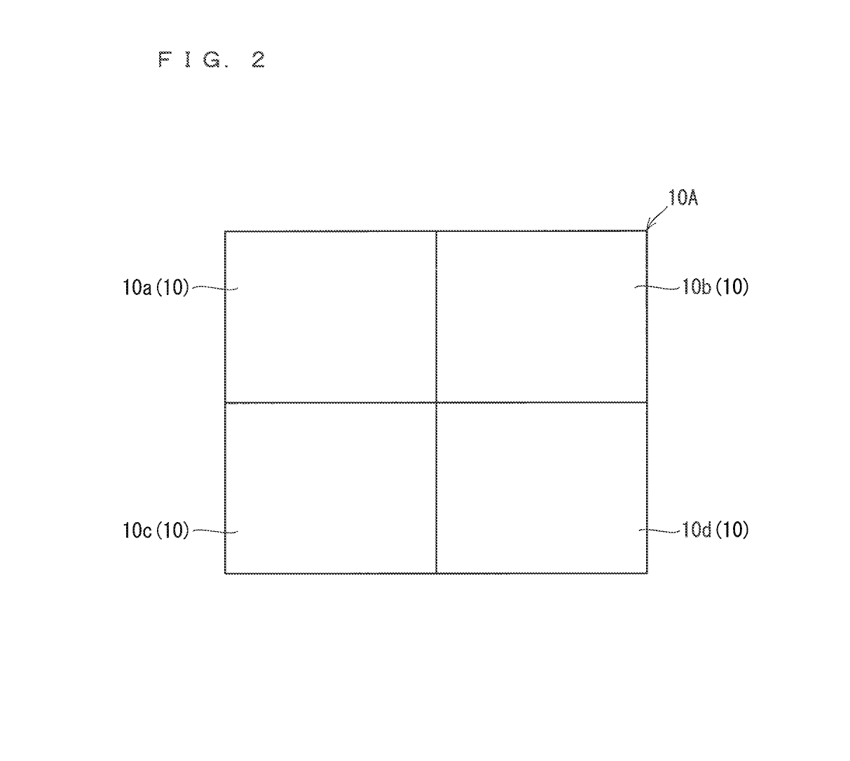

The projection video image display devices 100a, 100b, 100c and 100d each include screens 10a, 10b, 10c and 10d illustrated in FIG. 2.

The multiscreen display device 1000 includes a multiscreen 10A. As illustrated in FIG. 2, the multiscreen 10A is one screen formed with the screens 10a, 10b, 10c and 10d arrayed in a grid pattern. Each of the screens 10a, 10b, 10c and 10d is also described simply as a screen 10 below. The screen 10 is a screen which is irradiated with a video image light which configures a video image. In addition, the number of screens which form the multiscreen 10A is not limited to four, and may be two, three, five or more.

The projection video image display devices 100a, 100b, 100c and 100d are configured to be capable of communicating with each other using communication cables 7. Each projection video image display device 100 is allocated a unique ID number (ID1 to ID4) which does not overlap. More specifically, the projection video image display devices 100a, 100b, 100c and 100d are allocated ID1, ID2, ID3 and ID4, respectively.

One of a plurality of projection video image display devices 100 which forms the multiscreen display device 1000 functions as a master device, and the projection video image display devices 100 other than the master device function as slave devices.

In the present preferred embodiment, for example, the projection video image display device 100a to which the ID number “ID1” is allocated functions as the master device. Further, the projection video image display devices 100b, 100c and 100d to which the ID numbers “ID2”, “ID3” and “ID4”, respectively, function as slave devices.

The projection video image display device 100a as the master device integrally controls the projection video image display devices 100b, 100c and 100d as the slave devices. In addition, the projection video image display device 100a can communicate with the projection video image display devices 100b, 100c and 100d using the communication cables 7.

In addition, the projection video image display device 100a is also described as a master device Ma below. Further, the projection video image display devices 100b, 100c and 100d are also described as slave devices Sb, Sc and Sd, respectively below.

The multiscreen display device 1000 displays a video image on the multiscreen 10A when each projection video image display device 100 displays a video image on the screen 10.

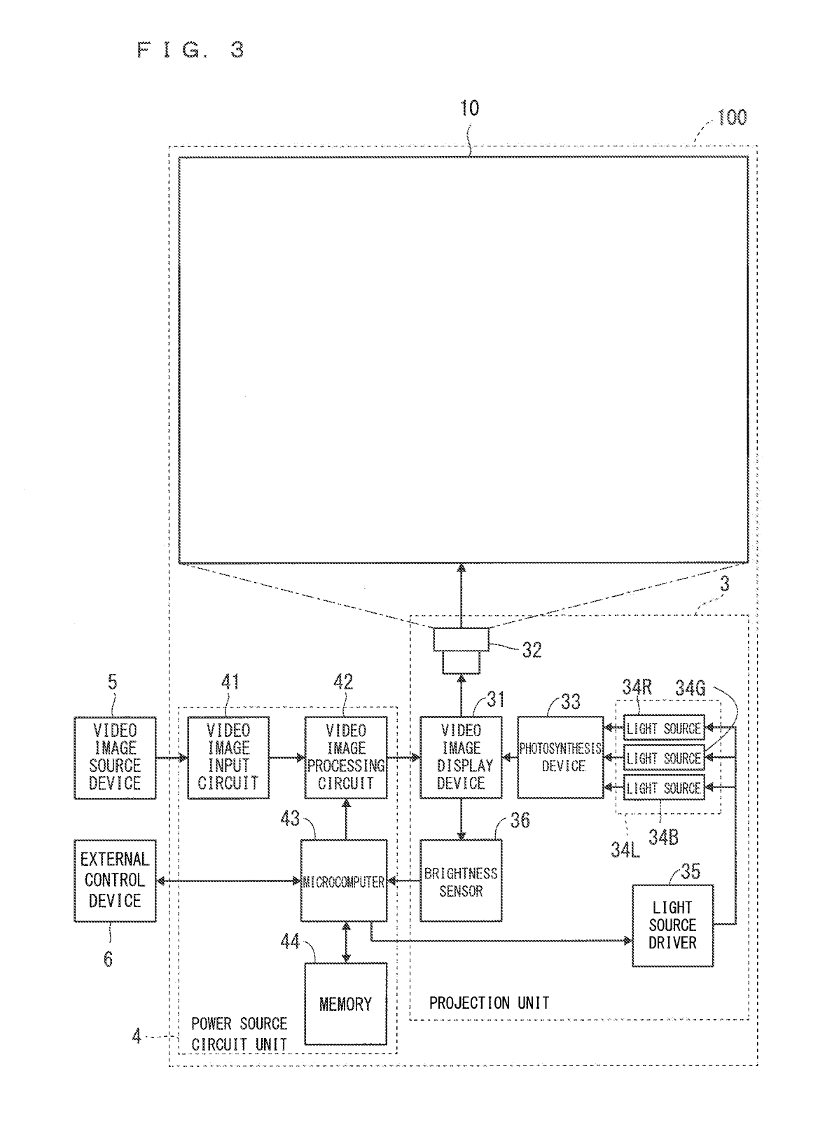

FIG. 3 is a block diagram illustrating a configuration of the projection video image display devices 100 as the master device or the slave devices. In addition, FIG. 3 illustrates a video image source device 5 and an external control device 6 which are not included in the projection video image display device 100, too.

The video image source device 5 is a device which outputs a video signal to each projection video image display device 100 which forms the multiscreen display device 1000. That is, each projection video image display device 100 receives an input of a video signal.

The external control device 6 is configured to be capable of communicating with each projection video image display device 100 which forms the multiscreen display device 1000. That is, each projection video image display device 100 communicates with the external control device 6.

The external control device 6 is, for example, a PC (Personal Computer). The external control device 6 has user interfaces for operating the external control device 6. The user interfaces are a keyboard, a mouse and the like. The external control device 6 has a function of controlling each projection video image display device 100 which forms the multiscreen display device 1000 according to a user operation of the user interfaces.

As illustrated in FIG. 3, the projection video image display device 100 includes the screen 10, a projection unit 3 and a power source circuit unit 4. The projection unit 3 projects a video image light on the screen 10 based on a video signal. The power source circuit unit 4 gives to the projection unit 3 a video signal which is subjected to predetermined signal processing.

Next, each configuration will be described in detail. First, the power source circuit unit 4 will be described in detail. The power source circuit unit 4 includes a video image input circuit 41, a video image processing circuit 42, a microcomputer 43 and a memory 44.

The video image input circuit 41 receives a video signal outputted from the video image source device 5 arranged outside the multiscreen display device 1000. Next, the video image input circuit 41 of the projection video image display device 100 converts the received video signal into a digital signal, and outputs the converted digital video signal to the video image processing circuit 42.

Although described in detail below, the video image processing circuit 42 performs image processing such as image quality adjustment on an image indicated by the received digital video signal. Next, the video image processing circuit 42 performs digital signal format conversion of converting the digital video signal which is subjected to the image processing into a video signal of a format which can be processed by the projection unit 3 (a video image display device 31 described below).

Red, green and blue are also referred to as R, G and B, respectively below. Digital video signals processed by the video image processing circuit 42 indicate an R signal, a G signal and a B signal.

Hereinafter, image quality adjustment performed by the video image processing circuit 42 will be described. The video image processing circuit 42 has an image quality adjusting function of independently increasing and decreasing levels of R, G and B signals of three primary colors indicated by digital video signals per each pixel which forms a video image and per primary color.

In the present preferred embodiment, a computing function of performing matrix computing of 3×3 expressed by following expression 1 on levels of R, G and B signals indicated by the digital video signals is implemented on the video image processing circuit 42. The video image processing circuit 42 performs image quality adjustment by performing computing according to expression 1.

$$\begin{matrix}[ Mathematical 1 ] & \\ ( \begin{matrix}Ro \\ Go \\ Bo\end{matrix} ) = ( \begin{matrix}RR & GR & BR \\ RG & GG & BG \\ RB & GB & BB\end{matrix} ) ( \begin{matrix}Ri \\ Gi \\ Bi\end{matrix} ) & ( EXPRESSION 1 )\end{matrix}$$

In expression 1, Ri, Gi and Bi indicate levels of R, G and B signals, respectively, indicated by a digital video signal inputted to the video image processing circuit 42. Further, in expression 1, RR, RG, RB, GR, GG, GB, BR, BG and BB are correction coefficients. Furthermore, in expression 1, Ro, Go and Bo indicate levels of R, G and B signals respectively after the R, G and B signals are corrected by the correction coefficients.

As a result of computing this expression 1, for example, a signal level of Ro is obtained by adding signal levels of Gi and Bi a little to an increased or decreased signal level of Ri. The video image processing circuit 42 executes adjustment (mainly chromaticity adjustment) of a brightness and a chromaticity of an R single color as the above image quality adjusting function by computing expression 1.

In addition, in a second preferred embodiment described below, a correction coefficient of expression 1 is calculated by the microcomputer 43 described below, and the video image processing circuit 42 uses the calculated correction coefficient as the correction coefficient of expression 1. The video image processing circuit 42 performs the above digital signal format conversion on a video signal after image quality adjustment. A signal obtained by digital signal format conversion is also referred to as a converted digital signal below. Further, the video image processing circuit 42 outputs the converted digital signal to the video image display device 31 of the projection unit 3 at a timing according to a command from the microcomputer 43.

The memory 44 is a storage unit which stores information and data.

The microcomputer 43 is controlled by the external control device 6 arranged outside the multiscreen display device 1000. Further, although described in detail below, the microcomputer 43 integrally controls each component of the projection video image display device 100.

Next, the projection unit 3 will be described in detail.

The projection unit 3 includes the video image display device 31, a projection lens 32, a photosynthesis device 33, a light source 34L, a light source driver 35 and a brightness sensor 36.

The video image display device 31 is, for example, a DMD (Digital Micromirror Device). That is, each projection video image display device 100 is a device of a single plate system using one DMD. In addition, the video image display device 31 is not limited to a DMD, and may be another video image display device.

The light source 34L is a light source which sequentially emits lights of three primary colors (red light, green light and blue light).

The light source 34L includes light sources 34R, 34G and 34B. Each of the light sources 34R, 34G and 34B is a semiconductor light emitting element. Each of the light sources 34R, 34G and 34B is, for example, an LED. The light source 34R is a red light source which emits a red light. The light source 34G is a green light source which emits a green light. The light source 34B is a blue light source which emits a blue light.

Each of the light sources 34R, 34G and 34B is also described simply as the light source 34 below. That is, each of a plurality of projection video image display devices 100 which forms the multiscreen display device 1000 includes the light source 34 formed with a semiconductor light emitting element. The light source 34 emits a light of a brightness corresponding to a magnitude of a current flowing in the light source 34. That is, the light source 34 emits a light of a brightness corresponding to a current to be supplied. The brightness of a light emitted from the light source 34 is different per brightness mode set to the projection video image display device 100.

Although described in detail below, the projection video image display device 100 displays a video image using the light emitted from the light source 34. A brightness of a video image displayed by the projection video image display device 100 using a light emitted from the light source 34 is also referred to as a video image brightness below. The video image brightness is a brightness of a video image displayed on the screen 10.

One of a plurality of types of brightness modes of different video image brightnesses is set to each projection video image display device 100 which forms the multiscreen display device 1000.

In addition, a user operates the external control device 6 to set the brightness mode of the projection video image display device 100. A brightness mode set to the projection video image display device 100 is also referred to as a set brightness mode below.

In the present preferred embodiment, a plurality of types of brightness modes is, for example, a normal mode and a power saving mode. The normal mode provides a higher video image brightness than a video image brightness of the power saving mode. The power saving mode provides a lower video image brightness than a video image brightness of the normal mode. The amount of a current supplied to the light source 34 in the power saving mode is less than the amount of a current supplied to the light source 34 in the normal mode. That is, the power saving mode provides less power consumption of the projection video image display device 100 than power consumption of the normal mode.

In addition, in the power saving mode, a lower limit of the amount of a current to be supplied to the light source 34 is determined based on various types of electronic circuits which form the projection video image display device 100 not from a point of view of a luminance of a video image when a user looks at the screen 10. Further, the video image brightness in each brightness mode is determined in advance.

Furthermore, the memory 44 further stores brightness mode information in advance. The brightness mode information is information for specifying a type of a brightness mode. The brightness mode information indicating that a brightness mode of the projection video image display device 100 is a normal mode is also referred to as brightness mode information α below. The brightness mode information α indicates a mode identifier “α”. The mode identifier “α” indicates that a brightness mode is the normal mode.

Further, brightness mode information indicating that the brightness mode of the projection video image display device 100 is a power saving mode is also referred to as brightness mode information β below. The brightness mode information β indicates a mode identifier “β”. The mode identifier “β” indicates that the brightness mode is the power saving mode.

The memory 44 stores brightness mode information corresponding to a brightness mode set to the projection video image display device 100. When, for example, the brightness mode set to the projection video image display device 100 is the normal mode, the brightness mode information α is stored in the memory 44.

In addition, the brightness modes are not limited to two types of the normal mode and the power saving mode, and may be three types or more.

The light source driver 35 controls the light sources 34R, 34G and 34B of the light source 34L to emit lights. More specifically, the light source driver 35 controls the light sources 34R, 34G and 34B to sequentially emit a red light, a green light and a blue light at different timings (time division) according to a command from the microcomputer 43.

More specifically, the light source driver 35 supplies a control current (drive current) to the light source 34 to cause each light source 34 to emit a light. The control current is a current for controlling a brightness of light emitted from each light source 34. The light source driver 35 supplies the control current to each light source 34 by way of time division. Consequently, a timing at which the light source 34L emits a light is controlled by way of time division.

The photosynthesis device 33 sequentially emits a red light, a green light and a blue light emitted from the light sources 34R, 34G and 34B, respectively.

The light emitted from each of the light sources 34R, 34G and 34B is irradiated on the video image display device 31 through the photo synthesis device 33, and then is irradiated on the screen 10 through the projection lens 32. In addition, the red light, the green light and the blue light are sequentially irradiated on the screen 10 at very short time intervals.

Hence, it appears to a user looking at the screen 10 that a video image obtained by synthesizing a red light video image, a green light video image and a blue light video image is irradiated on the screen 10. That is, the user sees colors mixed with red, green and blue on the screen 10. Consequently, a full-color video image is displayed on the screen 10.

The video image display device 31 modulates an intensity of the irradiated light according to the above converted digital signal received from the video image processing circuit 42, and leads the modulated light to the projection lens 32.

The microcomputer 43 controls a brightness of a light emitted from each of the light sources 34R, 34G and 34B through the light source driver 35. More specifically, the microcomputer 43 controls a control current supplied to each of the light sources 34R, 34G and 34B through the light source driver 35. Further, the microcomputer 43 is configured to be accessible to the memory 44. The microcomputer 43 stores brightness characteristics of a red light, a green light and a blue light and various items of data in advance in the memory 44. That is, the memory 44 stores brightness characteristics of the red light, the green light and the blue light of the projection video image display device 100 including the memory 44. Further, the microcomputer 43 reads brightness characteristics and various items of data stored in the memory 44 when necessary.

The brightness characteristics are characteristics indicating a relationship between a control current of the light source 34 and a video image brightness corresponding to the control current. A current value (value) of the control current for causing the light source 34 to operate is also referred to as a control current value below. Further, a video image brightness obtained only from a red light, a video image brightness obtained only from a green light and a video image brightness obtained only from a blue light are also referred to as an R brightness, a G brightness and a B brightness, respectively below.

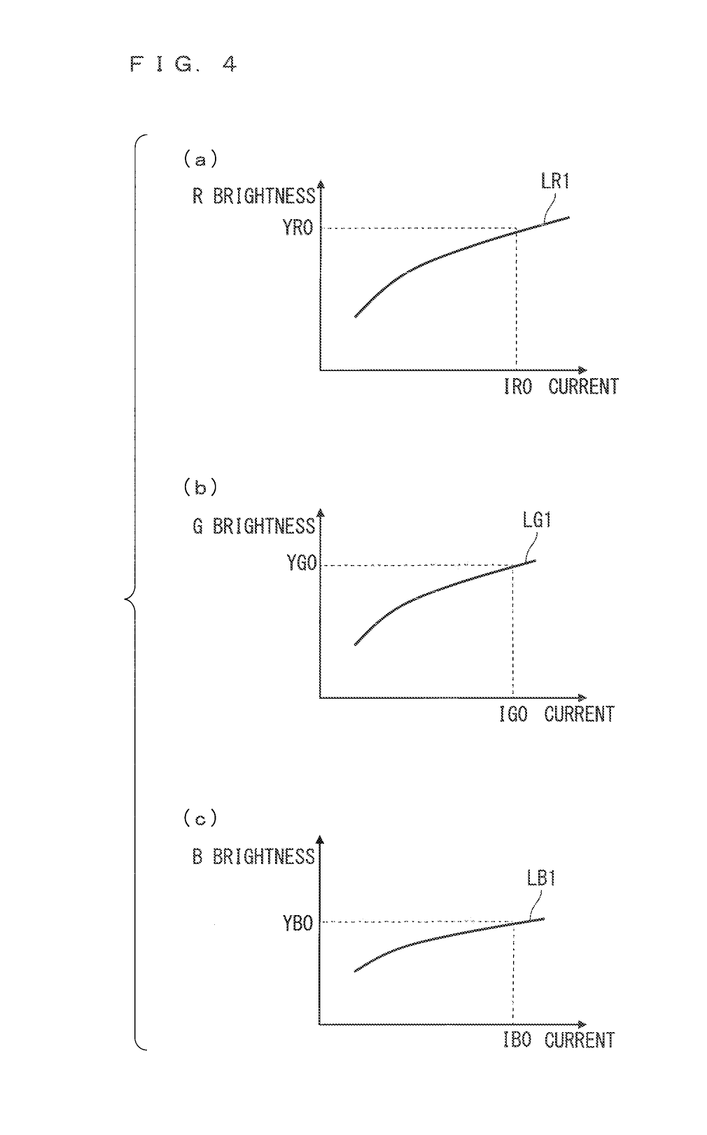

FIG. 4 is a view illustrating an example of brightness characteristics. Part (a) in FIG. 4 is a view illustrating an example of brightness characteristics LR1 corresponding to the light source 34R which emits a red light. In part (a) in FIG. 4, YR0 is a video image brightness in a state where a control current value of the light source 34R is IR0 and the screen 10 displays a video image when only a red light emitted from the light source 34R is irradiated on the screen 10.

Part (b) in FIG. 4 is a view illustrating an example of brightness characteristics LG1 corresponding to the light source 34G which emits a green light. In part (b) in FIG. 4, YG0 is a video image brightness in a state where a control current value of the light source 34G is IG0, and the screen 10 displays a video image when only the green light emitted from the light source 34G is irradiated on the screen 10.

Part (c) in FIG. 4 is a view illustrating an example of brightness characteristics LB 1 corresponding to the light source 34B which emits a blue light. In part (c) in FIG. 4, YB0 is a video image brightness in a state where a control current value of the light source 34B is IB0 and the screen 10 displays a video image when only a blue light emitted from the light source 34B is irradiated on the screen 10.

Each of the brightness characteristics LR1, LG1 and LB1 are also described simply as brightness characteristics L below. The brightness characteristics L are current/brightness characteristics indicating a relationship between a current (control current) and a brightness (video image brightness).

Further, by controlling the amount of a control current to supply to the light source 34, it is possible to control a brightness of a light emitted from the light source 34. Hence, in the present preferred embodiment, a control current value corresponding to each of the above different brightness modes is stored in the memory 44 in advance. That is, the memory 44 stores a control current value corresponding to each of the brightness modes.

In the present preferred embodiment, default setting values I0_α and I0_β of each of the light sources 34R, 34G and 34B are stored in advance in the memory 44 of each projection video image display device 100. The default setting value I0_α is a default control current value corresponding to the normal mode as the brightness mode. I0_α is, for example, 30(A). The default setting value I0_β is a default control current value corresponding to the power saving mode as the brightness mode. I0_β is, for example, 15(A).

Although described in detail below, the user operates the external control device 6 to change a brightness mode of the projection video image display device 100. In this case, the microcomputer 43 reads the control current value corresponding to the changed brightness mode from the memory 44, and performs control for supplying a control current of the control current value to the light source 34. Consequently, the user can quickly switch a brightness of a video image displayed by the projection video image display device 100.

In addition, the microcomputer 43 of the master device Ma and the microcomputer 43 of each of the slave devices Sb, Sc and Sd are configured to be capable of transmitting and receiving information to and from each other through the communication cables 7 and communication interfaces (not illustrated). For example, the microcomputer 43 of the master device Ma transmits a control command to the microcomputer 43 of each of the slave devices Sb, Sc and Sd through the communication cables 7.

The microcomputer 43 of the master device Ma and the microcomputer 43 of each of the slave devices Sb, Sc and Sd may be configured to be capable of communicating with each other without using the communication cables 7. For example, the master device Ma and each of the slave devices Sb, Sc and Sd may have a function of performing wireless communication with each other.

The brightness sensor 36 detects the amount of light which allows the microcomputer 43 to detect the amount of a video image light (brightness) to be projected on the screen 10. The brightness sensor 36 transmits the detected amount of the video image light to the microcomputer 43. In the present preferred embodiment, in the projection unit 3, the brightness sensor 36 receives from the video image display device 31 an unnecessary light which is not projected on the screen 10, detects the amount of the unnecessary light and transmits the detected amount of light to the microcomputer 43.

The microcomputer 43 detects (monitors) a pseudo brightness (video image brightness) of a video image light projected on the screen 10 based on the amount of received light. In addition, when a liquid crystal video image display device is used for the projection unit 3, the microcomputer 43 may detect a pseudo video image brightness based on the amount of light from a backlight.

Each projection video image display device 100 performs characteristics calculating process upon shipping from a factory or adjustment of a video image of a product. In the characteristics calculating process, the projection video image display device 100 calculates each of the brightness characteristics LR1, LG1 and LB1 in parts (a) to (c) in FIG. 4. More specifically, the projection video image display device 100 measures a brightness (video image brightness) of the screen 10 corresponding to a control current of each light source 34 per R, G and B using the brightness sensor 36 while changing the control current.

For example, the projection video image display device 100 supplies a control current only to the light source 34R, and measures a video image brightness using the brightness sensor 36 while changing the control current in a state where only a red light is irradiated on the screen 10. Consequently, the brightness characteristics LR1 are calculated. The brightness characteristics LG1 and LB1 are calculated according to the same manner as that for the brightness characteristics LR1.

Consequently, the projection video image display device 100 calculates the brightness characteristics LR1, LG1 and LB1. Further, the projection video image display device 100 stores the calculated brightness characteristics LR1, LG1 and LB1 in the memory 44 of the projection video image display device 100. Consequently, the brightness characteristics LR1, LG1 and LB1 are stored in the memory 44. That is, the memory 44 of each projection video image display device 100 stores the brightness characteristics LR1, LG1 and LB1 corresponding to the projection video image display device 100.

In addition, a video image brightness may be measured by a following process A in which the brightness sensor 36 is not used. In the process A, for example, an operator operates the external control device 6 such that the projection video image display device 100 irradiates the screen 10 with only a red light. The operator measures a video image brightness on the screen 10 using an illuminometer. Further, every time the operator operates the external control device 6 to change the control current of the light source 34R, the operator measures the video image brightness on the screen 10.

Consequently, the operator calculates the brightness characteristics LR1. Further, the operator operates the external control device 6 to store the calculated brightness characteristics LR1 in the memory 44. The brightness characteristics LG1 and LB 1 are also stored in the memory 44 according to the same method as that for the brightness characteristics LR1.

In addition, the multiscreen display device 1000 has the following problems if brightness adjustment processing described below is not performed. When the multiscreen display device 1000 is used for the first time, brightness variations may be generated in a video image displayed by each projection video image display device 100 due to variations upon manufacturing of each projection video image display device 100.

It is assumed that, in the case where the brightness adjustment processing described below is not performed, each projection video image display device 100 displays a white color on the entire screen 10 of the projection video image display device 100 according to a video signal of perfect white in a state where there are brightness variations. In this case, a brightness difference is generated between the screens 10 of the multiscreen 10A. As a result, the unity of video images displayed on the multiscreen 10A is lost.

In addition, the operator can perform an operation of adjusting the brightness of each projection video image display device 100 by way of visual checking or using measuring equipment to suppress the brightness difference. However, the operation is difficult and takes time.

Hence, in the present preferred embodiment, the brightness of each projection video image display device 100 is adequately and automatically adjusted even in following situations A and B to solve the above problem. An example of the situation A is a situation in which, during the operation of the multiscreen display device 1000, a user operates the external control device 6 to change the brightness mode of one of a plurality of projection video image display devices 100.

Further, an example of the situation B is a situation in which the projection video image display devices 100 of different brightness modes are mixed upon installation of the multiscreen display device 1000. Processing of enabling such brightness adjustment in this way will be described.

In the present preferred embodiment, the multiscreen display device 1000 performs processing (also referred to as brightness adjustment processing) of automatically adjusting a brightness taking into account the brightness mode of each projection video image display device 100. The brightness adjustment processing is mainly performed by the microcomputers 43 of the master device Ma and the slave devices Sb, Sc and Sd. Each of the slave devices Sb, Sc and Sd is also referred to simply as a slave device S below.

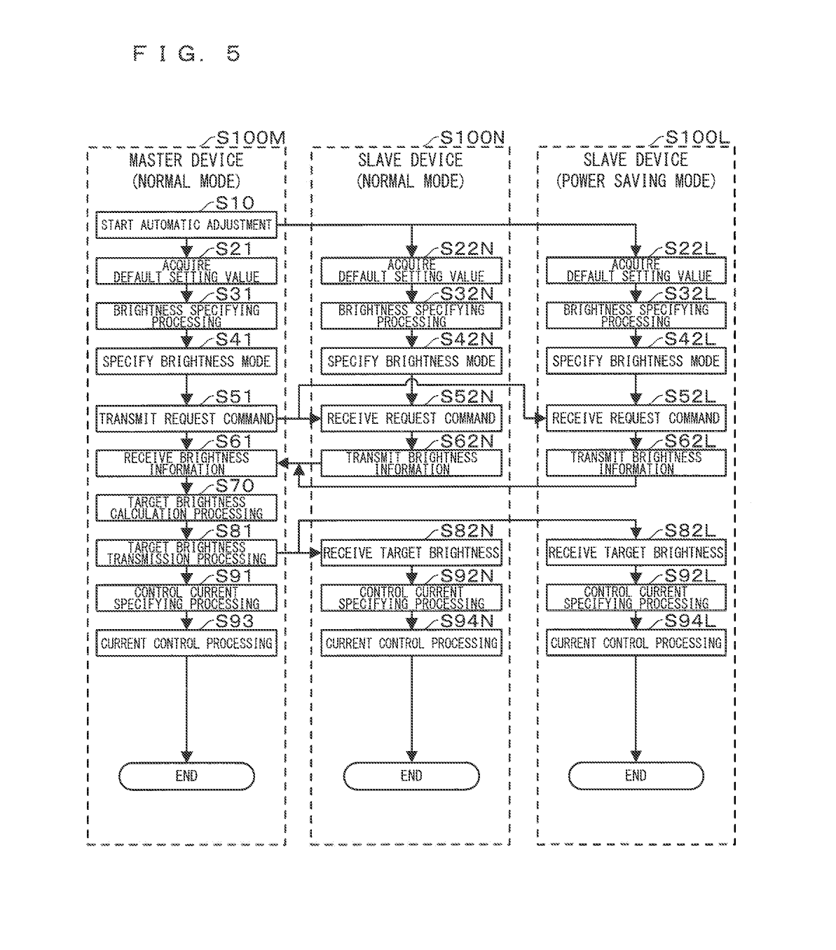

FIG. 5 is a flowchart of the brightness adjustment processing. The brightness adjustment processing is, for example, processing of automatically making adjustment of suppressing brightness variations between a plurality of projection video image display devices 100 in the above situation A or situation B.

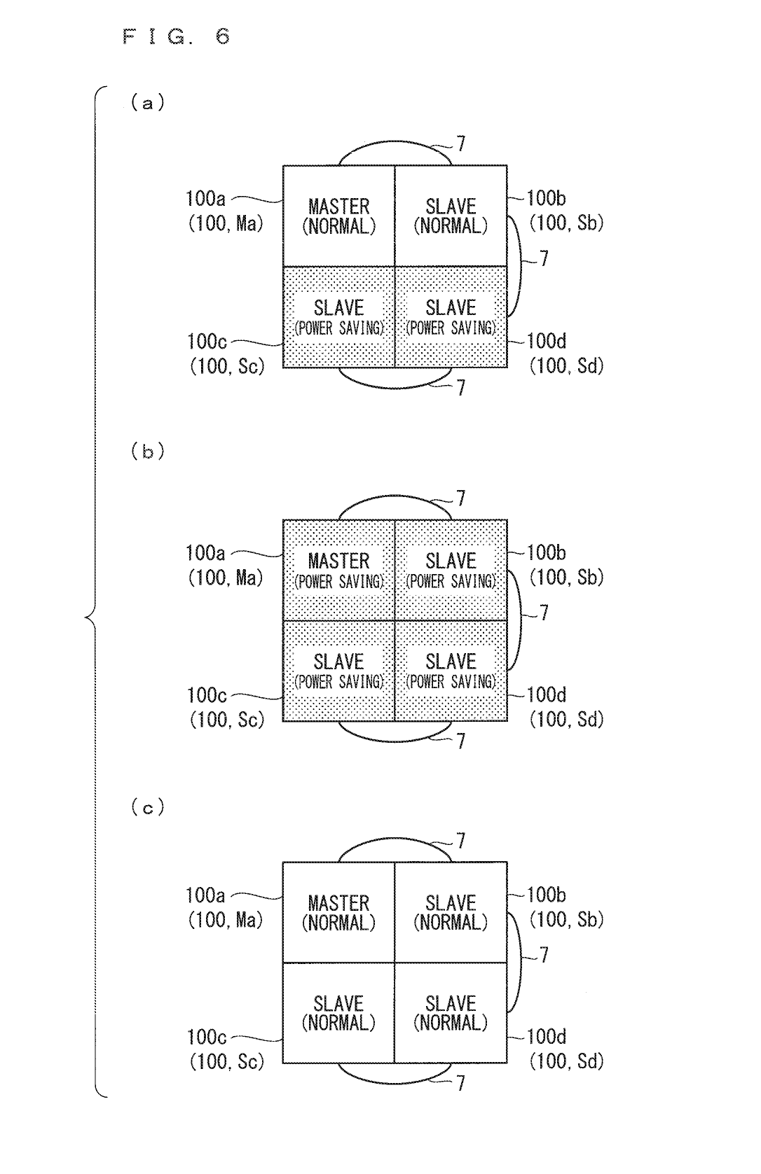

The brightness adjustment processing will be described below with reference to FIG. 5. First, the brightness adjustment processing under the condition A will be described. Under the condition A, the normal mode is set as the brightness mode to the master device Ma (projection video image display device 100a) and the slave device Sb (projection video image display device 100b) as illustrated in part (a) in FIG. 6. Further, the power saving mode is set as the brightness mode to the slave device Sc (projection video image display device 100c) and the slave device Sd (projection video image display device 100d).

Further, under the condition A, the brightness mode information α is stored in the memory 44 of each of the master device Ma and the slave device Sb. Furthermore, the brightness mode information β is stored in the memory 44 of each of the slave devices Sc and Sd.

A current value (control current value) of the control current of the light source 34R in the normal mode is also described as IRn_α below. Further, a current value (control current value) of the control current of the light source 34G in the normal mode is also described as IGn_α below. Furthermore, a current value (control current value) of the control current of the light source 34B in the normal mode is also described as IBn_α below.

In addition, “n” of each of IRn_α, IGn_α and IBn_α is a natural number. The n corresponds to a number indicated by an ID number (for example, ID 1) allocated to each projection video image display device 100.

Meanwhile, in case of n=1, IRn_α, IGn_α and IBn_α are control current values of the light sources 34R, 34G and 34B, respectively, included in the projection video image display device 100a (master device Ma). Further, in case of n=2, IRn_α, IGn_α and IBn_α are control current values of the light sources 34R, 34G and 34B, respectively, included in the projection video image display device 100b (slave device Sb).

Furthermore, in case of n=3, IRn_α, IGn_α and IBn_α are control current values of the light sources 34R, 34G and 34B, respectively, included in the projection video image display device 100c (slave device Sc). Still further, in case of n=4, IRn_α, IGn_α and IBn_α are control current values of the light sources 34R, 34G and 34B, respectively, included in the projection video image display device 100d (slave device Sd).

Moreover, a current value (control current value) of the control current of the light source 34R in the power saving mode is also described as IRn_β below. Besides, a current value (control current value) of the control current of the light source 34G in the power saving mode is also described as IGn_β below. In addition, a current value (control current value) of the control current of the light source 34B in the power saving mode is also described as IBn_β below. “n” of IRn_β, IGn_β and IBn_β and “n” of IRn_α, IGn_α and IBn_α are the same. In addition, IRn_β, IGn_β and IBn_β are the same as above IRn_α, IGn_α and IBn_α and therefore will not be described in detail repeatedly.

In addition, n indicated by a value defined below is the same as “n” of IRn_α. That is, a value to which n=1 is assigned is a value specified or calculated by the master device Ma. Further, a value to which n=2 is assigned is a value specified or calculated by the slave device Sb. Furthermore, a value to which n=3 is assigned is a value specified or calculated by the slave device Sc. Still further, a value to which n=4 is assigned is a value specified or calculated by the slave device Sd.

The brightness adjustment processing in FIG. 5 includes steps S100M, S100N and S100L. Step S100M is a step performed by the master device Ma. Step S100N is a step performed by the slave device S in the normal mode. Step S100L is a step performed by each slave device S in the power saving mode.

Processing of steps S100M, S100N and S100L under the above condition A will be described below.

First, in step S10, the microcomputer 43 of the master device Ma transmits a command for starting automatic adjustment to the slave devices Sb, Sc and Sd.

Next, the microcomputer 43 of the master device Ma acquires the default setting value I0_α by reading as a default control current value from the memory 44 the default setting value I0_α of each light source 34 corresponding to the normal mode (S21). Further, the microcomputer 43 of the slave device S in the normal mode acquires the default setting value I0_α by reading from the memory 44 the default setting value I0_α of each light source 34 corresponding to the normal mode (S22N).

Furthermore, the microcomputer 43 of each slave device S in the power saving mode acquires the default setting value I0_β by reading from the memory 44 the default setting value I0_β of each light source 34 corresponding to the power saving mode (S22L).

In addition, although the default setting values I0_α and I0_β are acquired from the memory 44, the default setting values I0_α and I0_β are not limited to these. The default setting values I0_α and I0_β may be, for example, given to each slave device S together with a command transmitted from the master device Ma in step S10.

Next, the microcomputer 43 of each projection video image display device 100 performs brightness specifying processing (S31, S32N and S32L). That is, the microcomputer 43 of each of the master device Ma and the slave devices Sb, Sc and Sd performs the brightness specifying processing.

The brightness specifying processing is processing where the microcomputer 43 of each projection video image display device 100 specifies a video image brightness which the projection video image display device 100 can output using the brightness characteristics L stored in the memory 44 of the projection video image display device 100. That is, the microcomputer 43 of each of the master device Ma and the slave devices Sb, Sc and Sd specifies a video image brightness by the brightness specifying processing. Hereinafter, processing performed by the microcomputer 43 of the master device Ma in the brightness specifying processing (S31) will be described as an example.

A brightness (R brightness) corresponding to I0_α and indicated by the brightness characteristics LR1 in part (a) in FIG. 4 is also described as YR0n_α below. Further, a brightness (G brightness) corresponding to I0_α and indicated by the brightness characteristics LG1 in part (b) in FIG. 4 is also described as YG0n_β below. Furthermore, a brightness (B brightness) corresponding to I0_β and indicated by the brightness characteristics LB 1 in part (c) in FIG. 4 is also described as YB0n_α below.

Still further, a brightness (R brightness) corresponding to I0_β and indicated by the brightness characteristics LR1 in part (a) in FIG. 4 is also described as YR0n_β below. Moreover, a brightness (G brightness) corresponding to I0_β and indicated by the brightness characteristics LG1 in part (b) in FIG. 4 is also described as YG0n_β below. Besides, a brightness (B brightness) corresponding to I0_β and indicated by the brightness characteristics LB 1 in part (c) in FIG. 4 is also described as YB0n_β below.

In addition, a brightness specified from the brightness characteristics L per set brightness mode and corresponding to a control current is also referred to as a characteristic brightness below. That is, the characteristic brightness is a brightness specified from the brightness characteristics L. Further, the characteristic brightness is a video image brightness which corresponds to a brightness mode set to the projection video image display device 100 and which the projection video image display device 100 can output.

In the brightness specifying processing (S31), the microcomputer 43 specifies a characteristic brightness corresponding to a control current value of each light source 34 and indicated by the brightness characteristics L using the brightness characteristics L stored in the memory 44.

In addition, IRn_α, IGn_α and IBn_α which are control current values of each light source 34 are I0_α at a point of time in step S31. Hence, in the brightness specifying processing, the microcomputer 43 specifies a characteristic brightness corresponding to a default control current value and indicated by the brightness characteristics L.

More specifically, in the brightness specifying processing (S31), the microcomputer 43 of the master device Ma specifies a characteristic brightness YR0n_α corresponding to the default setting value I0_α and indicated by the brightness characteristics LR1 using the brightness characteristics LR1 stored in the memory 44. Further, the microcomputer 43 specifies characteristic brightnesses YG0n_α and YB0n_α using the brightness characteristics LG1 and LB1 according to the same manner as that for the characteristic brightness YR0n_α.

Furthermore, in the brightness specifying processing (S32N), the microcomputer 43 of the slave device S specifies characteristic brightnesses YR0n_α, YG0n_α and YB0n_α of the slave device S according to the similar manner in step S31.

Still further, in the brightness specifying processing (S32L), the microcomputer 43 of each slave device S specifies a characteristic brightness YR0n_β corresponding to the default setting value I0_β and indicated by the brightness characteristics LR1. Moreover, the microcomputer 43 specifies the characteristic brightnesses YG0n_β and YB0n_β using the brightness characteristics LG1 and LB1 according to the same manner as that for the brightness YR0n_β.

Next, the microcomputer 43 of the master device Ma reads the brightness mode information α from the memory 44 in step S41. The microcomputer 43 specifies based on the brightness mode information α that the brightness mode set to the projection video image display device 100 (master device Ma) including the microcomputer 43 is the normal mode. In addition, in step S42N, the microcomputer 43 of the slave device S performs the same processing as that in step S41.

Further, in step S42L, the microcomputer 43 of each slave device S reads the brightness mode information β from the memory 44. The microcomputer 43 specifies based on the brightness mode information β that the brightness mode set to the projection video image display device 100 (slave device S) including the microcomputer 43 is the power saving mode.

Next, the microcomputer 43 of the master device Ma transmits a request command to the slave devices Sb, Sc and Sd. The request command is a command which is acquired by the microcomputer 43 of each slave device S and is used to request brightness information and a mode identifier. The brightness information is information indicating YR0n_s, YG0n_s and YB0n_s.

“n” of YR0n_s, YG0n_s and YB0n_s is one of 2 to 4. Further “s” of YR0n_s, YG0n_s and YB0n_s is a mode identifier indicated by brightness mode information read by the microcomputer 43 of the slave device S. When, for example, the microcomputer 43 of the slave device S reads the brightness mode information α, “s” of YR0n_s, YG0n_s and YB0n_s is a mode identifier “α”.

Further, the microcomputer 43 of each slave device S receives a request command (S52N and S52L).

Next, the microcomputer 43 of the slave device S in the normal mode transmits brightness information indicating specified YR0n_α, YG0n_α and YB0n_α and the mode identifier “α” to the master device Ma according to a request command (S62N). For example, the microcomputer 43 of the slave device Sb in the normal mode transmits brightness information indicating specified YR02_α, YG02_α and YB2n_α and the mode identifier “α” to the master device Ma according to a request command.

Further, the microcomputer 43 of each slave device S in the power saving mode transmits brightness information indicating specified YR0n_β, YG0n_β and YB0n_β and the mode identifier β″ to the master device Ma according to a request command (S62L). For example, the microcomputer 43 of the slave device Sc in the power saving mode transmits brightness information indicating specified YR03_β, YG03_β and YB03_β and the mode identifier “β” to the master device Ma according to a request command.

Further, the microcomputer 43 of the master device Ma receives a plurality of pieces of brightness information from the slave devices Sb, Sc and Sd (S61).

Target brightness calculation processing is performed in step S70. In the target brightness calculation processing, the microcomputer 43 of the master device Ma calculates a target brightness per brightness mode based on the characteristic brightnesses of the master device Ma and the characteristic brightnesses of each slave device S. That is, the microcomputer 43 of the master device Ma is a calculating unit which calculates a target brightness.

The characteristic brightnesses of the above master device Ma are the characteristic brightnesses YR0n_α, YG0n_α a and YB0n_α in case of n=1. The characteristic brightnesses of the above slave device S are the characteristic brightnesses YR0n_s, YG0n_s and YB0n_s. In YR0n_s, YG0n_s and YB0n_s, n is one of 2 to 4 and s is α or β of the mode identifier.

More specifically, in the target brightness calculation processing, the microcomputer 43 of the master device Ma calculates a target brightness per brightness mode (set brightness mode) based on the characteristic brightnesses of the master device Ma and a set brightness mode of the master device Ma, and the characteristic brightnesses of each slave device S and the set brightness mode of each slave device S.

The target brightness is a brightness of a target of each projection video image display device 100 of the same brightness mode. That is, the target brightness is a brightness common to each of a plurality of projection video image display devices 100 of the same brightness mode.

The target brightness calculation processing will be described in detail below using a specific example. In the target brightness calculation processing, the microcomputer 43 of the master device Ma first learns set brightness modes of the slave devices Sb, Sc and Sd based on the mode identifier indicated by brightness information received from each slave device S.

In this regard, the set brightness mode of the slave device Sb is the normal mode, and the set brightness modes of the slave devices Sc and Sd are the power saving mode. In addition, the set brightness mode of the master device Ma is the normal mode.

A group to which the projection video image display device 100 whose set brightness mode is the normal mode belongs is also described as a group α below. Further, a group to which the projection video image display device 100 whose set brightness mode is the normal mode belongs is also described as a group β below.

Further, a characteristic brightness of the projection video image display device 100 belonging to the group α is also described as Y_α below. Furthermore, a characteristic brightness of the projection video image display device 100 belonging to the group β is also described as Y_β below.

The microcomputer 43 of the master device Ma determines as the characteristic brightnesses Y_α the characteristic brightnesses YR01_α, YG01_α and YB01_α of the master device Ma belonging to the group α, and the characteristic brightnesses YR02_α, YG02_α and YB02_α received from the slave device Sb.

Further, the microcomputer 43 of the master device Ma determines as the characteristic brightness Y13 the characteristic brightnesses YR0n_β, YG0n_β and YB0n_β received from each of the slave devices Sc and Sd belonging to the group β. n of the characteristic brightnesses YR0n_β, YG0n_β, YB0n_β is 3 or 4.

Next, the microcomputer 43 of the master device Ma calculates the same target brightness per set brightness mode to reduce brightness variations among the screens 10 of the projection video image display devices 100 of the same brightness mode. For example, the microcomputer 43 calculates different target brightnesses for each of the normal mode and the power saving mode.

Target brightnesses of R, G and B of the projection video image display device 100 belonging to the group α are also referred to as target brightnesses YRT_α, YGT_α and YBT_α, respectively, below. The target brightness YRT_α is the target brightness of R. The target brightness YGT_α is the target brightness of G. The target brightness YBT_α is the target brightness of B.

Further, target brightnesses of R, G and B of the projection video image display device 100 belonging to the group β are also described as target brightnesses YRT_β, YGT_β and YBT_β, respectively, below. The target brightness YRT_β is the target brightness of R. The target brightness YGT_β is the target brightness of G. The target brightness YBT_β is the target brightness of B.

Further, each of YRT_α and YRT_β is also described as YRT_s below. Furthermore, each of YGT_α and YGT_β is also described as YGT_s below. Still further, each of YBT_α and YBT_β is also described as YBT_s below. “s” of YRT_s, YGT_s and YBT_s is the mode identifier α or β.

First, the microcomputer 43 of the master device Ma calculates as the target brightness for the group α corresponding to the normal mode the characteristic brightness Y_α indicating a minimum value among a plurality of characteristic brightnesses Y_α of each of R, G and B. The plurality of characteristics Y_α are the characteristic brightnesses YR01_α, YG01_α, YB01_α, YR02_α, YG02_α and YB02_α.

For example, the target brightness YRT_α corresponding to R is calculated according to YRT_α=Min(YR01_α, YR02_α). YRT_α=Min(YR0_α, YR02_α) is an expression of calculating as the target brightness YRT_α a characteristic brightness indicating a minimum value among YR01_α and YR02_α.

Further, the target brightness YGT_α corresponding to G is calculated according to YGT_α=Min(YG01_α, YG02_α). Furthermore, the target brightness YBT_α corresponding to B is calculated according to YBT_α=Min(YB01_α, YB02_α).

The reason why the characteristic brightness Y_α indicating a minimum value among a plurality of characteristic brightnesses Y_α is calculated as a target brightness will be described below. Meanwhile, it is assumed that the target brightness is the characteristic brightness Y_α indicating values other than the minimum value. In this case, a video image brightness of the projection video image display device 100 whose video image brightness lowers the most cannot satisfy a temporary target brightness. Therefore, brightness variations become remarkable. Hence, the target brightness of each projection video image display device 100 belonging to the group α is inevitably adjusted to a characteristic brightness indicating a minimum value.

Next, the microcomputer 43 of the master device Ma calculates as a target brightness for the group β corresponding to the power saving mode the characteristic brightness Y_β indicating a maximum value among a plurality of characteristic brightnesses Y_β of each of R, G and B. The plurality of characteristic brightnesses Y_β are characteristic brightnesses YR03_β, YG03_{—} β, YB03_β, YR04_β, YG04_β and YB04_β.

The target brightness YRT_β corresponding to R is calculated according to YRT_β Max(YR03_β, YR04_β). YRT_β=Max(YR03_β, YR04_β) is an expression of calculating as the target brightness YRT_β the characteristic brightness indicating a maximum value among YR03_β and YR04_β. Further, the target brightness YGT_β corresponding to G is calculated according to YGT_β=Max(YG03_β, YG04_β). Furthermore, the target brightness YBT_β corresponding to B is calculated according to YBT_β=Max(YB03_β, YB04_β).

The reason why the characteristic brightness Y_β indicating a maximum value among a plurality of characteristic brightnesses Y_β is calculated as a target brightness will be described below. This is the reason why a default current value upon the power saving mode is set to a value which cannot be lowered from a present value due to restriction of an electronic circuit which forms the projection video image display device 100. Therefore, the target brightness of each projection video image display device 100 belonging to the group β needs to be adjusted to the characteristic brightness indicating a maximum value.

The target brightness calculation processing is finished as described above.

Next, target brightness transmission processing is performed in step S81. In the target brightness transmission processing, the microcomputer 43 of the master device Ma transmits the calculated target brightnesses YRT_s. YGT_s and YBT_s to the slave device S belonging to one of the groups α and β according to the mode identifiers α and β.

For example, the microcomputer 43 transmits the target brightnesses YRT_α, YGT_α and YBT_α to the slave device Sb belonging to the group α. Further, the microcomputer 43 transmits the target brightnesses YRT_β, YGT_β and YBT_β to the slave devices Sc and Sd belonging to the group β.

The microcomputer 43 of each slave device S receives the target brightnesses YRT_s, YGT_s and YBT_s (S82N, S82L). For example, the microcomputer 43 of the slave device Sc receives the target brightnesses YRT_β, YGT_β and YBT_β (S82L).

A control current value corresponding to the target brightness YRT_α and indicated by the brightness characteristics LR1 in part (a) in FIG. 4 is also described as IRTn_α below. Further, a control current value corresponding to the target brightness YGT_α and indicated by the brightness characteristics LG1 in part (b) in FIG. 4 is also described as IGTn_α below. Furthermore, a control current value corresponding to the target brightness YBT_α and indicated by the brightness characteristics LB 1 in part (c) in FIG. 4 is also described as IBTn_α below.

Still further, a control current value corresponding to the target brightness YRT_β and indicated by the brightness characteristics LR1 in part (a) in FIG. 4 is also described as IRTn_β below. Moreover, a control current value corresponding to the target brightness YGT_β and indicated by the brightness characteristics LG1 in part (b) in FIG. 4 is also described as IGTn_β below. Besides, a control current value corresponding to the target brightness YBT_β and indicated by the brightness characteristics LB 1 in part (c) in FIG. 4 is also described as IBTn_β below.

Further, each of IRTn_α and IRTn_β is also described as IRTn_s below. Furthermore, each of IGTn_α and IGTn_β is also described as IGTn_s below. Still further, each of IBTn_α and IBTn_β is also described as IBTn_s below.

“n” of IRTn_s, IGTn_s and IBTn_s is the same as “n” of above IRn_α, and therefore will not be described in detail again. “s” of IRTn_s, IGTn_s and IBTn_s is the mode identifier α or β.

Next, the microcomputer 43 of each projection video image display device 100 performs control current specifying processing (S91, S92N and S92L). That is, the microcomputer 43 of each of the master device Ma and the slave devices Sb, Sc and Sd performs the control current specifying processing.

The control current specifying processing is processing where the microcomputer 43 of each projection video image display device 100 specifies a control current value using the brightness characteristics L stored in the memory 44 of the projection video image display device 100. A little more specifically, the control current specifying processing is processing where each projection video image display device 100 specifies a control current value which is a value of a control current corresponding to a target brightness calculated according to the brightness mode set to the projection video image display device 100 using the brightness characteristics L. More specifically, the control current specifying processing is processing where each projection video image display device 100 specifies a control current value corresponding to the target brightness using the brightness characteristics L and the received target brightness.

Hereinafter, processing performed by the microcomputer 43 of the master device Ma in the control current specifying processing (S91) will be described as an example. In the control current specifying processing (S91), the microcomputer 43 specifies a control current value IRT1_α corresponding to the target brightness YRT_α and indicated by the brightness characteristics LR1 using the brightness characteristics LR1 stored in the memory 44. Further, the microcomputer 43 specifies the control current values IGT1_α and IBT1_α using the brightness characteristics LG1 and LB1 according to the same manner as that for the control current value IRT1_α.

Furthermore, in the control current specifying processing (S92N), the microcomputer 43 of the slave device Sb in the normal mode specifies IRT2_α, IGT2_α and IBT2_α of the slave device Sb according to the same manner as in step S91.

Still further, in the control current specifying processing (S92L), the microcomputer 43 of each slave device S in the power saving mode specifies IRTn_β, IGTn_β and IBTn_β of each slave device S according to the same manner in step S91. “n” of IGTn_β and IBTn_β is 3 or 4.

Next, the microcomputer 43 of each projection video image display device 100 performs current control processing (S93, S94N and S94L). That is, the microcomputer 43 of each of the master device Ma and the slave devices Sb, Sc and Sd performs the current control processing.

The current control processing is processing where each projection video image display device 100 supplies a current indicating a specified target control current value to the light source 34 of the projection video image display device 100.

Hereinafter, processing performed by the microcomputer 43 of the master device Ma in the current control processing (S93) will be described as an example. In the current control processing (S93), the microcomputer 43 controls the light source driver 35 to supply a current indicating the specified target control current value IRT1_α to the light source 34R. The specified control current value IRT1_α is a target control current value, that is, a target control current value.

Further, the microcomputer 43 controls the light source driver 35 to supply a current indicating the specified target control current value IGT1_α to the light source 34G. Furthermore, the microcomputer 43 controls the light source driver 35 to supply a current indicating the specified target control current value IBT1_α to the light source 34B.

Still further, in the current control processing (S94N), the microcomputer 43 of the slave device Sb controls the light source driver 35 according to the same manner as in step S93.

Moreover, in the current control processing (S94L), the microcomputer 43 of each slave device S controls the light source driver 35 according to the same manner as in step S93. Processing of the slave device Sc will be described below as an example.

The microcomputer 43 of the slave device Sc controls the light source driver 35 to supply a current indicating the specified target control current value IRT1_β to the light source 34R. Further, the microcomputer 43 controls the light source driver 35 to supply a current indicating the specified target control current value IGT1_β to the light source 34G. Furthermore, the microcomputer 43 controls the light source driver 35 to supply a current indicating the specified target control current value IBT1_β to the light source 34B.

In the above current control processing (S93, S94N and S94N), each of the master device Ma and the slave devices Sb, Sc and Sd changes a control current to be supplied to each light source 34 of each device based on the calculated target brightness. Further, steps S100M, S100N and S100L are finished, and the brightness adjustment processing in FIG. 5 is finished.

In addition, processing where the normal mode and the power saving mode are mixed as the brightness mode set to each projection video image display device as illustrated in part (a) in FIG. 6 has been described above. In addition, upon an actual operation of the multiscreen display device 1000, as illustrated in part (b) in FIG. 6 and in part (c) in FIG. 6, a plurality of brightness modes set to each of a plurality of projection video image display devices 100 are set to the same brightness mode, and all brightness modes of the plurality of projection video image display devices 100 are switched to operate in some cases.

In this regard, all brightness modes of the plurality of projection video image display devices 100 are the power saving mode as illustrated in part (b) in FIG. 6. In this case, each of the slave devices Sb, Sc and Sd transmits a brightness value and the mode identifier “β” upon the power saving mode to the master device Ma in step S62L in FIG. 5. Further, the brightness of each projection video image display device 100 is adjusted in a step subsequent to step S70.

Furthermore, all brightness modes of the plurality of projection video image display devices 100 are the normal mode as illustrated in part (c) in FIG. 6. In this case, each of the slave devices Sb, Sc and Sd transmits to the master device Ma a brightness value and the mode identifier “α” upon the normal mode in step S62N in FIG. 5. Further, the brightness of each projection video image display device 100 is adjusted in a step subsequent to step S70.

As described above, the microcomputer 43 calculates a target brightness per brightness mode in the present preferred embodiment. Each projection video image display device 100 specifies a target control current value corresponding to the target brightness calculated according to the brightness mode set to the projection video image display device 100. Each projection video image display device 100 supplies a current indicating the specified control current value to the light source 34 of the projection video image display device 100.

Consequently, it is possible to control a light source suitable to the brightness mode. Consequently, it is possible to suppress brightness variations of each projection video image display device to which the same brightness mode is set.

Further, in the present preferred embodiment, even when the projection video image display devices 100 of different brightness modes are mixed in the multiscreen display device 1000, grouping is performed per brightness mode of the multiscreen display device 1000. Furthermore, the master device Ma calculates an optimal target brightness by transmitting and receiving the target brightness to and from the slave device S of each group.

Consequently, it is possible to suppress brightness variations between the projection video image display devices 100 per group even when the projection video image display devices 100 of different brightness modes are mixed in the multiscreen display device 1000. That is, it is possible to suppress brightness variations between the projection video image display devices 100 of the same brightness mode. For example, it is possible to suppress brightness variations between the projection video image display devices 100 of the same brightness mode even in the above situations A and B. As a result, it is possible to enhance unity of video images displayed on the multiscreen display device 1000.

Further, even when, for example, a setting pattern of a brightness mode is switched as illustrated in parts (a), (b) and (c) in FIG. 6, the master device Ma updates per brightness mode an optimal value of the target brightness of the projection video image display device 100 belonging to a group corresponding to the brightness mode. Consequently, it is possible to uniformly keep an output brightness of the multiscreen display device 1000 at all times.

In addition, a projection video image display device which uses a semiconductor light source generally can adjust an output brightness and power consumption by a current supplied to the semiconductor light source. Hence, in the multiscreen display device, for example, a group of projection video image display devices which display video images at a high brightness and a group of projection video image display devices which display video images at a low brightness to save power are mixed to operate in some cases.

That is, when each projection video image display device is grouped and operated, it is necessary to calculate an optimal target brightness per group. In addition, the related art A cannot calculate a target brightness for a group and adjust a brightness of the multiscreen display device corresponding to a group.

Meanwhile, the multiscreen display device 1000 according to the present preferred embodiment employs the above configuration and, consequently, can adjust a brightness of the multiscreen display device corresponding to the group.

Further, although the brightness modes set to each projection video image display device 100 are two types of the normal mode and the power saving mode in the present preferred embodiment, the brightness modes are not limited to these. The brightness modes may be three types or more. In this case, the microcomputer 43 is configured to calculate a target brightness which achieves an object of each brightness mode. Hence, a configuration which includes different types of brightness modes from the normal mode and the power saving mode and a different number of brightness modes is also incorporated in the scope of the present invention.

This is because the point of the present invention is to mix brightnesses of the projection video image display devices 100 of the same type. To achieve this point, the microcomputer 43 groups brightness values which can be outputted from a plurality of projection video image display devices 100 per brightness mode, and calculates a target brightness per group according to the object of the brightness mode. Further, each projection video image display device 100 adjusts a control current of the light source 34 using the target brightness corresponding to the brightness mode of each projection video image display device.

In addition, although the microcomputer 43 of the master device Ma calculates a target brightness in the present preferred embodiment, calculation of a target brightness is not limited to this. The external control device 6 which communicates with each projection video image display device 100 may calculate a target brightness on behalf of the microcomputer 43 of the master device Ma. That is, the external control device 6 is a computing device which calculates a target brightness. In this case, the external control device 6 performs each processing in step S100M in FIG. 5 on behalf of the microcomputer 43 of the master device Ma.

That is, the external control device 6 calculates a target brightness per brightness mode using brightness information acquired from each slave device S. Further, the external control device 6 transmits the calculated target brightness corresponding to each brightness mode, to the slave device S corresponding to each brightness mode.

As described above, the external control device 6 can provide the following effect by calculating a target brightness on behalf of the microcomputer 43. More specifically, the external control device 6 calculates a target brightness, so that it is not necessary to implement a function of calculating a target brightness in each projection video image display device 100 which forms the multiscreen display device 1000.

Consequently, it is possible to achieve the present invention at low cost compared to a case where a function of calculating a target brightness is implemented in the projection video image display device 100 by altering the projection video image display devices 100 in the multiscreen display device 1000 which has already been installed.

### Second Preferred Embodiment

Processing of suppressing brightness variations among a plurality of projection video image display devices 100 of a same brightness mode has been described with the first preferred embodiment. In this regard, a chromaticity value (chromaticity characteristics) of an LED corresponding to a control current value is different per LED due to, for example, manufacturing variations. Moreover, a control current value is not calculated taking into account a chromaticity in the first preferred embodiment. Therefore, the chromaticity is likely to vary more or less in a multiscreen display device 1000 according to the first preferred embodiment.

Hence, a multiscreen display device according to the present preferred embodiment performs processing of enabling suppression of not only brightness variations but also chromaticity variations. In addition, the multiscreen display device according to the present preferred embodiment is the multiscreen display device 1000 in FIG. 1. Processing different from the processing in the first preferred embodiment will be mainly described below.

In the present preferred embodiment, a microcomputer 43 stores in advance in a memory 44 various items of control data including the above brightness characteristics LR1, LG1 and LB1 and, in addition, chromaticity characteristics and image quality adjustment values which a video image processing circuit 42 uses to adjust a brightness and a chromaticity of each of R, G and B. The chromaticity characteristics are characteristics indicating a chromaticity corresponding to a control current value of each of light sources 34R, 34G and 34B. Part of image quality adjustment values are, for example, correction coefficients according to above expression 1. The microcomputer 43 reads various items of control data from the memory 44 when necessary.

A chromaticity of a video image displayed by the projection video image display device 100 using a light emitted from a light source 34 is also referred to as a video image chromaticity below. The video image chromaticity is a chromaticity of a video image displayed on the screen 10.

Further, the above control current values IRTn_s, IGTn_s and IBTn_s are also described simply as control current values IRT, IGT and IBT, respectively below.

In the present preferred embodiment, each projection video image display device 100 performs the above characteristic calculating process before shipping from a factory. Consequently, the memory 44 of each projection video image display device 100 stores brightness characteristics LR1, LG1 and LB1 corresponding to the projection video image display device 100.

Further, each projection video image display device 100 further performs characteristics calculating process A before shipping from a factory. In the characteristics calculating process A, the projection video image display device 100 gradually changes a control current to be supplied to each light source 34 per R, G and B, and measures a video image chromaticity upon this change. Consequently, the projection video image display device 100 calculates chromaticity characteristics indicating a relationship between a control current of the light source 34 and a video image chromaticity corresponding to the control current.

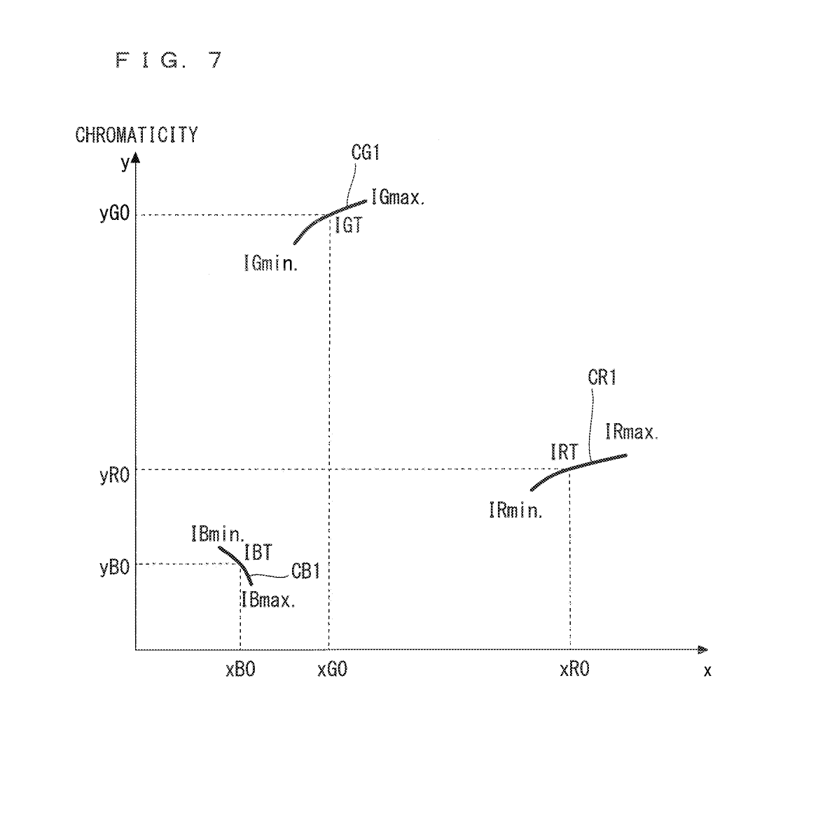

FIG. 7 is a view illustrating an example of chromaticity characteristics. More specifically, FIG. 7 illustrates chromaticity coordinates of an xy chromaticity diagram in a CIE-XYZ color coordinate system.

In FIG. 7, x and y indicate chromaticities. Further, FIG. 7 illustrates chromaticity characteristics CR1, CG1 and CB1. The chromaticity characteristics CR1 are characteristics indicating a chromaticity corresponding to a control current value IRT. The chromaticity characteristics CG1 are characteristics indicating a chromaticity corresponding to a control current value IGT. The chromaticity characteristics CB1 are characteristics indicating a chromaticity corresponding to a control current value IBT. That is, each of the chromaticity characteristics CR1, CG1 and CB1 is current chromaticity characteristics indicating a chromaticity corresponding to a control current value.

More specifically, in the characteristics calculating process A, the projection video image display device 100 calculates the chromaticity characteristics CR1, CG1 and CB1. Further, the projection video image display device 100 stores the chromaticity characteristics CR1, CG1 and CB 1 in the memory 44 of the projection video image display device 100. That is, the memory 44 of each projection video image display device 100 stores the chromaticity characteristics CR1, CG1 and CB1 corresponding to the projection video image display device 100. Each of the chromaticity characteristics CR1, CG1 and CB1 is also referred to simply as chromaticity characteristics C below.

Next, the multiscreen display device 1000 performs processing (referred to as brightness/chromaticity adjustment processing below) for automatically adjusting a brightness and a chromaticity taking into account a brightness mode of each projection video image display device 100. The brightness/chromaticity adjustment processing is processing of suppressing brightness and chromaticity variations between the projection video image display devices 100 of the same brightness mode. The brightness/chromaticity adjustment processing is performed when, for example, the multiscreen display device 1000 is used for the first time. Further, the brightness/chromaticity adjustment processing is performed when, for example, the multiscreen display device 1000 is installed.

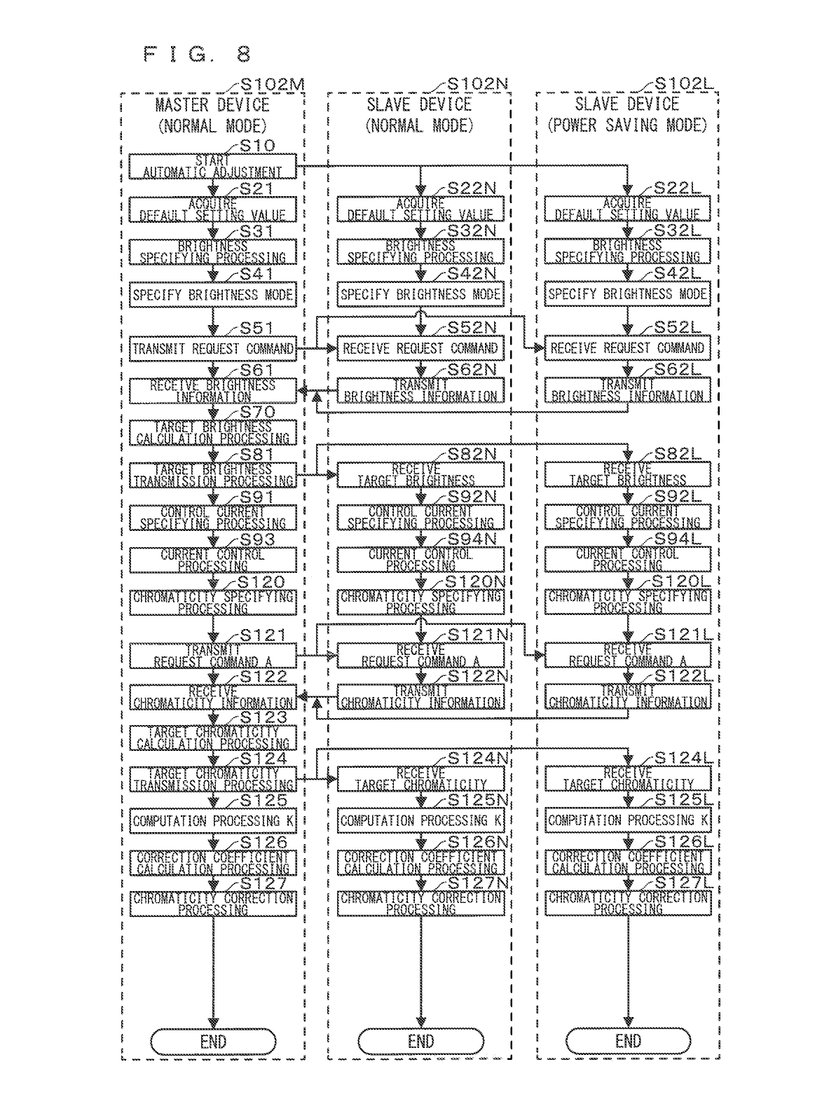

FIG. 8 is a flowchart of the brightness/chromaticity adjustment processing. In FIG. 8, processing of the same step numbers as the step numbers in FIG. 5 is performed as the same processing as processing described in the first preferred embodiment, and therefore will not be described in detail again. Differences from the first preferred embodiment will be mainly described below.

First, the brightness/chromaticity adjustment processing will be described under the above condition A. As described above, under the condition A, the normal mode is set as the brightness mode to a master device Ma (projection video image display device 100a) and a slave device Sb (projection video image display device 100b) as illustrated in part (a) in FIG. 6. Further, the power saving mode is set as the brightness mode to a slave device Sc (projection video image display device 100c) and a slave device Sd (projection video image display device 100d).

The brightness adjustment processing in FIG. 8 includes steps S102M, S102N and S102L. Step S102M is a step performed by the master device Ma. Step S102N is a step performed by a slave device S in the normal mode. Step S102L is a step performed by each slave device S in the power saving mode.

First, in steps S10 to S93, steps S22N to S94N and steps S22L to S94N in FIG. 8, the same processing as the processing in the first preferred embodiment will be performed.

Chromaticity values corresponding to the above control current value IRTn_α and indicated by the chromaticity characteristics CR1 in FIG. 7 are also described as xR0n_α and yR0n_α below. Further, chromaticity values corresponding to the above control current value IGTn_α and indicated by the chromaticity characteristics CG1 are also described as xG0n_α and yG0n_α below. Furthermore, chromaticity values corresponding to the above control current value IBTn_α and indicated by the chromaticity characteristics CB1 are also described as xB0n_α and yB0n_α below.

Still further, chromaticity values corresponding to the above control current value IRTn_β and indicated by the chromaticity characteristics CR1 are also described as xR0n_β and yR0n_β below. Moreover, chromaticity values corresponding to an above control current value IGTn_β and indicated by the chromaticity characteristics CG1 are also described as xG0n_β and yG0n_β below. Besides, chromaticity values corresponding to the above control current value IBTn_β and indicated by the chromaticity characteristics CB1 are also described as xB0n_β and yB0n_β below.

Further, each of xR0n_α and xR0n_β is also described as xR0n_s below. Furthermore, each of xG0n_α and xG0n_β is also described as xG0n_s below. Still further, each of xB0n_α and xB0n_β is also described as xB0n_s below.

Moreover, each of yR0n_α and yR0n_β is also described as yR0n_s below. Besides, each of yG0n_α and yG0n_β is also described as yG0n_s below. In addition, each of yB0n_α and yB0n_β is also described as yB0n_s below.

“n” of xR0n_s, xG0n_s, xB0n_s, yR0n_s, yG0n_s and yB0n_s is the same as above “n” of IRn_α, and therefore will not be described in detail again. “s” of xR0n_s, xG0n_s, xB0n_s, yR0n_s, yG0n_s and yB0n_s is a mode identifier α or β.

Next, the microcomputer 43 of each projection video image display device 100 performs chromaticity specifying processing (S120, S120N and S120L). That is, the microcomputer 43 of each of the master device Ma and the slave devices Sb, Sc and Sd performs chromaticity specifying processing.

The chromaticity specifying processing is processing where the microcomputer 43 of each projection video image display device 100 specifies a chromaticity using the chromaticity characteristics C stored in the memory 44 of the projection video image display device 100.

Hereinafter, processing performed by the microcomputer 43 of the master device Ma in the chromaticity specifying processing (S120) will be described as an example. In the chromaticity specifying processing (S120), the microcomputer 43 specifies the chromaticity values xR0n_α and yR0n_α corresponding to the control current value IRTn_α and indicated by the chromaticity characteristics CR1 using the chromaticity characteristics CR1 stored in the memory 44. Further, the microcomputer 43 specifies the chromaticity values xG0n_α, yG0n_α, xB0n_α and yR0n_α using the chromaticity characteristics CG1 and CB1 and the brightness characteristics LG1 and LB 1 according to the same manner as that for the chromaticity values xR0n_α and yR0n_α.

Furthermore, in the chromaticity specifying processing (S120N), the microcomputer 43 of the slave device Sb in the normal mode specifies chromaticity values xG02_α, yG02_α, xB02_α and yB02_α of the slave device Sb according to the same manner as in step S120.

Still further, in the chromaticity specifying processing (S120L), the microcomputer 43 of each slave device S in the power saving mode specifies chromaticity values xR0n_β, yR0n_β, xG0n_β, yG0n_β, xB0n_β and yB0n_β of each slave S according to the same manner as in step S120. “n” of the chromaticity values xR0n_β, yR0n_β, xG0n_β, yG0n_β, xB0n_β and yB0n_β is 3 or 4.

Next, the microcomputer 43 of the master device Ma transmits the request command A to the slave devices Sb, Sc and Sd (S121). The request command A is a command which the microcomputer 43 of each slave device S acquires to request chromaticity information and a mode identifier. The request command A is a command which the microcomputer 43 of each slave device S acquires to request chromaticity information and a mode identifier. The chromaticity information is information indicating the chromaticity values xR0n_s, xG0n_s, xB0n_s, yR0n_s, yG0n_s and yB0n_s corresponding to the set brightness mode of each slave device S.

Further, the microcomputer 43 of each slave device S receives the request command A (S121N and S121L).

Next, the microcomputer 43 of the slave device S in the normal mode transmits to the master device Ma chromaticity information indicating the specified chromaticity values xR0n_α, xG0n_α, xB0n_α, yR0n_α, yG0n_α and yB0n_α and the mode identifier “α” according to the request command A (S122N).

Further, the microcomputer 43 of each slave device S in the power saving mode transmits to the master device Ma chromaticity information indicating the specified chromaticity values xR0n_β, xG0n_β, xB0n_β, yR0n_β, yG0n_β and yB0n_β and the mode identifier β″ according to the request command A (S122L). For example, the microcomputer 43 of the slave device Sc in the power saving mode transmits to the master device Ma chromaticity information indicating the specified chromaticity values xR03_β, xG03_β, xB03_β, yR03_β, yG03_β and yB03_β and the mode identifier “β” according to the request command A.

Further, the microcomputer 43 of the master device Ma receives a plurality of pieces of chromaticity information from the slave devices Sb, Sc and Sd (S122).

A chromaticity value (chromaticity) corresponding to a control current value specified by the microcomputer 43 in the above control current specifying processing is also referred to as a specified chromaticity below. The specified chromaticity is a chromaticity specified in the above chromaticity specifying processing by the microcomputer 43 of the master device Ma or the slave device S. That is, the specified chromaticities are chromaticity values (chromaticities) corresponding to the control current values IRTn_s, IGTn_s and IBTn_s specified in control current specifying processing. The specified chromaticities are xR0n_s, xG0n_s, xB0n_s, yR0n_s, yG0n_s and yB0n_s.

In step S123, target chromaticity calculation processing is performed. Although described in detail below, in the target chromaticity calculation processing, the microcomputer 43 of the master device Ma calculates a target chromaticity for each of brightness modes based on the specified chromaticities specified by the master device Ma, a brightness mode set to the master device Ma, specified chromaticities specified by each slave device S and the brightness mode set to each slave device S. The target chromaticity is a chromaticity which is a target for each projection video image display device 100 of the same brightness mode. That is, the target chromaticity is a common chromaticity which can be reproduced by each of a plurality of projection video image display devices 100 of the same brightness mode.

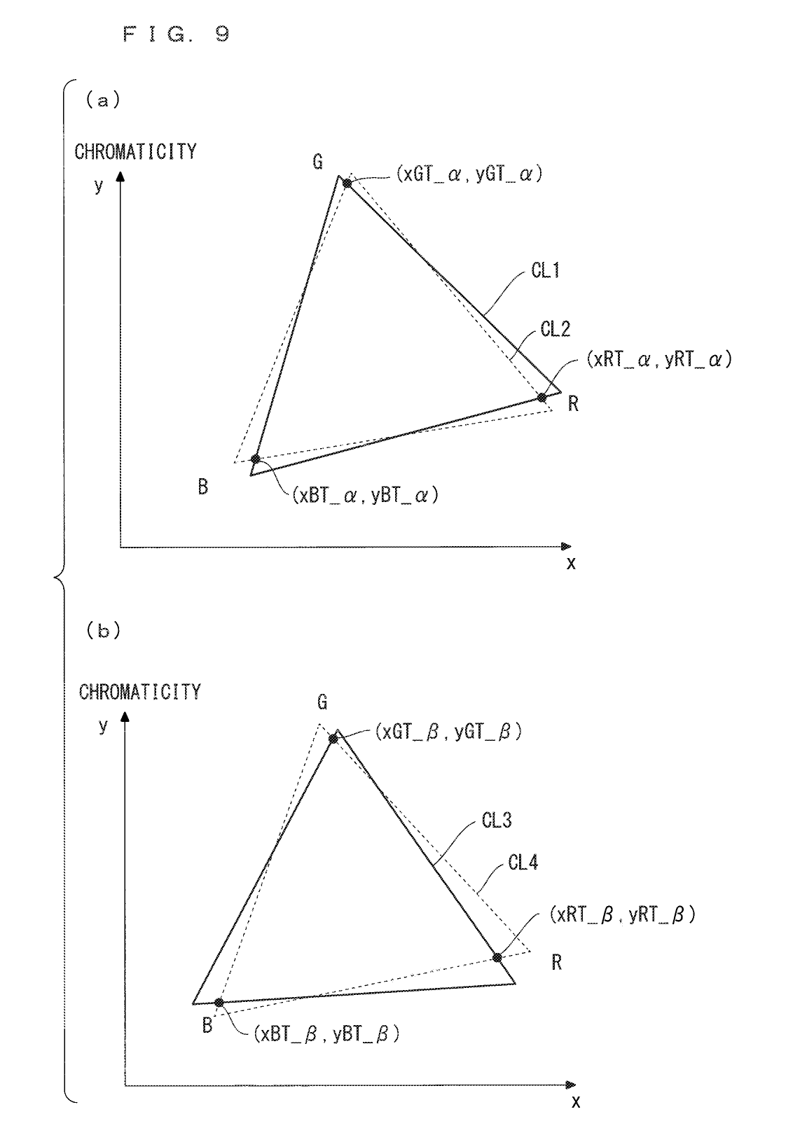

A triangle having the chromaticity values xR01_α and yR01_α, the chromaticity values xG01_α and yG01_α and the chromaticity values xB01_α and yB01_α at apexes in the chromaticity coordinates in the xy chromaticity diagram is also described as chromaticity characteristics CL1 below (see part (a) in FIG. 9). The chromaticity characteristics CL1 are configured by each chromaticity value specified by the master device Ma.

Further, a triangle having the chromaticity values xR02_α and yR02_α, the chromaticity values xG02_α and yG02_α and the chromaticity values xB02_α and yB02_α at apexes in the chromaticity coordinates in the xy chromaticity diagram is also described as chromaticity characteristics CL2 below (see part (a) in FIG. 9). The chromaticity characteristics CL2 are configured by each chromaticity value specified by the slave device Sb.

Further, a triangle having the chromaticity values xR03_β and yR03_β, the chromaticity values xG03_β and yG03_β and the chromaticity values xB03_β and yB03_β at apexes in the chromaticity coordinates in the xy chromaticity diagram is also described as chromaticity characteristics CL3 below (see part (b) in FIG. 9). The chromaticity characteristics CL3 are configured by each chromaticity value specified by the slave device Sc.

Further, a triangle having the chromaticity values xR04_β and yR04_β, the chromaticity values xG04_β and yG04_β and the chromaticity values xB04_β and yB04_β at apexes in the chromaticity coordinates in the xy chromaticity diagram is also described as chromaticity characteristics CL4 below (see part (b) in FIG. 9). The chromaticity characteristics CL4 are configured by each chromaticity value specified by the slave device Sd. Each of the chromaticity characteristics CL1, CL2, CL3 and CL 4 is referred to simply as chromaticity characteristics CL below.

Target chromaticities corresponding to the normal mode (group α) are also described as target chromaticities xRT_α, yRT_α, xGT_α, yGT_α, xBT_α and yBT_α below. Further, target chromaticities corresponding to the power saving mode (group β) are also described as target chromaticities xRT_β, yRT_β, xGT_β, yGT_β, xBT_β and yBT_β below.

Further, each of the target chromaticities xRT_α and xRT_β is also described as xRT_s below. Furthermore, each of the target chromaticities xGT_α and xGT_β is also described as xGT_s below. Still further, each of the target chromaticities xBT_α and xBT_β is also described as xBT_s below.

Moreover, each of the target chromaticities yRT_α and yRT_β is also described as yRT_s below. Besides, each of the target chromaticities yGT_α and yGT_β is also described as yGT_s below. In addition, each of the target chromaticities yBT_α and yBT_β is also described as yBT_s below.

“s” of xRT_s, xGT_s, xBT_s, yRT_s, yGT_s and yBT_s is the mode identifier α or β.

Further, target chromaticities corresponding to the normal mode are also referred to as normal target chromaticities below. Furthermore, target chromaticities corresponding to the power saving mode are also referred to as power saving target chromaticities below.

Next, a method of calculating a target chromaticity per brightness mode in target chromaticity calculation processing will be described. FIG. 9 is a view for explaining the method of calculating the target chromaticity. Further, FIG. 9 is a view illustrating each chromaticity characteristics CL in the chromaticity coordinates of the xy chromaticity diagram. Part (a) in FIG. 9 illustrates the chromaticity characteristics CL 1 and CL2. Part (b) in FIG. 9 illustrates the chromaticity characteristics CL3 and CL 4.

In the target chromaticity calculation processing, the microcomputer 43 of the master device Ma calculates as target chromaticities the chromaticities of three points in a region which a plurality of triangles (chromaticity characteristics CL) overlaps and near the apexes of each triangle. In other words, the microcomputer 43 calculates as a target chromaticity a chromaticity which is the most closest to a chromaticity of white among one or more points at which each chromaticity characteristics CL cross near each of the three apexes of each chromaticity characteristics CL (triangle).

First, calculation of the normal target chromaticities will be described. Referring to part (a) in FIG. 9, the microcomputer 43 calculates a chromaticity at a point at which the chromaticity characteristics CL1 and CL2 cross near each of the three apexes of each of the chromaticity characteristics CL1 and CL2 as the target chromaticities xRT_α and yRT_α, the target chromaticities xGT_α and yGT_α and the target chromaticities xRT_α and yBT_α.

For example, the microcomputer 43 calculates chromaticities at points at which the chromaticity characteristics CL1 and CL2 cross near the apex close to R (red) of each of the chromaticity characteristics CL1 and CL2 as target chromaticities (xRT_α and yRT_α) which are normal target chromaticities.

Next, calculation of a power saving target chromaticity will be described. Referring to part (b) in FIG. 9, the microcomputer 43 calculates chromaticities at points at which the chromaticity characteristics CL3 and CL4 cross near each of the three apexes of each of the chromaticity characteristics CL3 and CL4 as the target chromaticities xRT_β and yRT_β, the target chromaticities xGT_β and yGT_β and the target chromaticities xBT_β and yBT_β.

For example, the microcomputer 43 calculates a chromaticity at a point at which the chromaticity characteristics CL3 and CL4 cross near the apex close to R (red) of each of the chromaticity characteristics CL3 and CL4 as the target chromaticity (xRT_β and yRT_β) which is a power saving target chromaticity. Thus, the target chromaticity is calculated per brightness mode.

Next, target chromaticity transmission processing is performed in step S124. In the target chromaticity transmission processing, the microcomputer 43 of the master device Ma transmits the calculated target chromaticities xRT_s, xGT_s, xBT_s, yRT_s, yGT_s and yBT_s to the slave device S belonging to one of the groups α and β according to the mode identifiers α and β.

For example, the microcomputer 43 transmits the target chromaticities xRT_α, xGT_α, xBT_α, yRT_α, yGT_α and yBT_α to the slave device Sb belonging to the group α. Further, the microcomputer 43 transmits the target chromaticities xRT_β, xGT_β, xBT_β, yRT_β, yGT_β and yBT_β to the slave devices Sc and Sd belonging to the group 13.

The microcomputer 43 of each slave device S receives the target chromaticities xRT_s, xGT_s, xBT_s, yRT_s, yGT_s and yBT_s (S124N and S124L). The microcomputer 43 of the slave device Sb receives the target chromaticities xRT_α, xGT_α, xBT_α, yRT_α, yGT_α and yBT_α (S124N). Further, the microcomputer 43 of each slave device S belonging to the group β receives the target chromaticities xRT_β, xGT_β, xBT_β, yRT_β, yGT_β and yBT_β (S124L).

Next, the microcomputer 43 of each projection video image display device 100 performs computation processing K (S125, S125N and S125L). That is, the microcomputer 43 of each of the master device Ma and the slave devices Sb, Sc and Sd performs the computation processing K.

Stimulus values corresponding to the group α and corresponding to R are also described as XR0n_α and ZR0n_α below. Further, stimulus values corresponding to the group α and corresponding to G are also described as XG0n_α and ZG0n_α below. Furthermore, stimulus values corresponding to the group α and corresponding to B are also described as XB0n_α and ZB0n_α below.

Still further, stimulus values corresponding to the group β and corresponding to R are also described as XR0n_β and ZR0n_β below. Moreover, stimulus values corresponding to the group β and corresponding to G are also described as XG0n_β and ZG0n_β below. Besides, stimulus values corresponding to the group β and corresponding to B are also described as XB0n_β and ZB0n_β below.

Further, each of XR0n_α and XR0n_β is also described as XR0n_s below. Furthermore, each of XG0n_α and XG0n_β is also described as XG0n_s below. Still further, each of XB0n_α and XB0n_β is also described as XB0n_s below.

Moreover, each of ZR0n_α and ZR0n_β is also described as ZR0n_s below. Besides, each of ZG0n_α and ZG0n_β is also described as ZG0n_s below. In addition, each of ZB0n_α and ZG0n_β is also referred to as ZG0n_s below.

“n” of XR0n_s, XG0n_s, XB0n_s, ZR0n_s, ZG0n_s and ZB0n_s is the same as the above “n” of IRn_α, and therefore will not be described in detail again. Further, “s” of XR0n_s, XG0n_s, XB0n_s, ZR0n_s, ZG0n_s and ZB0n_s is the mode identifier α or β. In the computation processing K, XR0n_s, XG0n_s, XB0n_s, ZR0n_s, ZG0n_s and ZB0n_s which are tristimulus values of each of R, G and B are calculated per brightness mode. A little more specifically, in the computation processing K, target brightnesses YRT_s, YGT_s and YBT_s calculated in step S70 and chromaticity values xR0n_s, xG0n_s, xB0n_s, yR0n_s, yG0n_s and yB0n_s specified by the chromaticity specifying processing are substituted in following expression 2. Consequently, XR0n_s, XG0n_s, XB0n_s, ZR0n_s, ZG0n_s and ZB0n_s are calculated per brightness mode.

$$\begin{matrix}[ Mathematical 2 ] & \\ \begin{matrix}xR0n\_s = XR0n\_s / ( XR0n\_s + YRT\_s + ZR0n\_s ) \\ yR0n\_s = YRT\_s / ( XR0n\_s + YRT\_s + ZR0n\_s ) \\ xG0n\_s = XG0n\_s / ( XG0n\_s + YGT\_s + ZG0n\_s ) \\ yG0n\_s = YGT\_s / ( XG0n\_s + YGT\_s + ZG0n\_s ) \\ xB0n\_s = XB0n\_s / ( XB0n\_s + YBT\_s + ZB0n\_s ) \\ yB0n\_s = YBT\_s / ( XB0n\_s + YBT\_s + ZB0n\_s )\end{matrix} \} & ( EXPRESSION 2 )\end{matrix}$$

Hereinafter, processing performed by the microcomputer 43 of the master device Ma in the computation processing K (S125) will be described as an example. In the computation processing K (S125), the microcomputer 43 of the master device Ma substitutes in expression 2 the target brightnesses YRT_α, YGT_α and YBT_α and the chromaticity values xR0n_α, xG0n_α, xB0n_α, yR0n_α, yG0n_α and yB0n_α calculated in step S70. Consequently, the microcomputer 43 calculates XR0n_α, XG0n_α, XB0n_α, ZR0n_α, ZG0n_α and ZB0n_α corresponding to the normal mode (group α).

Further, in the computation processing K (S125N), the microcomputer 43 of the slave device Sb in the normal mode calculates XR0n_α, XG0n_α, XB0n_α, ZR0n_α, ZG0n_α and ZB0n_α according to the same manner as in step S125.

Furthermore, in the computation processing K (S125L), the microcomputer 43 of each slave device S in the power saving mode calculates XR0n_β, XG0n_β, XB0n_β, ZR0n_β, ZG0n_β, and ZB0n_β according to the same manner as in step S125.

Target stimulus values corresponding to the group α and corresponding to R are also described as XRT_α and ZRT_α below. Further, target stimulus values corresponding to the group α and corresponding to G are also described as XGT_α and ZGT_α below. Furthermore, target stimulus values corresponding to the group α and corresponding to B are also described as XBT_α and ZBT_α below.

Still further, target stimulus values corresponding to the group β and corresponding to R are also described as XRT_β and ZRT_β below. Moreover, target stimulus values corresponding to the group β and corresponding to G are also described as XGT_β and ZGT_β below. Besides, target stimulus values corresponding to the group β and corresponding to B are also described as XBT_β and ZBT_β below.

Further, each of XRT_α and XRT_β is also described as XRT_s below. Furthermore, each of XGT_α and XGT_β is also described as XGT_s below, Still further, each of XBT_α and XBT_β is also described as XBT_s below.

Moreover, each of ZRT_α and ZRT_β is also described as ZRT_s below. Besides, each of ZGT_α and ZGT_β is also described as ZGT_s below. In addition, each of ZBT_α and ZBT_β is also described as ZBT_s below.

“s” of XRT_s, ZRT_s, XGT_s, ZGT_s, XBT_s and xBT_s is the mode identifier α or β.

Further, in the computation processing K, XRT_s, ZRT_s, XGT_s, ZGT_s, XBT_s and ZBT which are target tristimulus values of each of R, G and B are calculated per brightness mode.

A little more specifically, in the computation processing K, the target brightnesses YRT_s, YGT_s and YBT_s calculated in step S70 and the target chromaticities xRT_s, xGT_s, xBT_s, yRT_s, yGT_s and yBT_s calculated in step S123 are substituted in following expression 3. Consequently, XRT_s, ZRT_s, XGT_s, ZGT_s, XBT_s and ZBT_s are calculated per brightness mode,

$$\begin{matrix}[ Mathematical 3 ] & \\ \begin{matrix}xRT\_s = XRT\_s / ( XRT\_s + YRT\_s + ZRT\_s ) \\ yRT\_s = YRT\_s / ( XRT\_s + YRT\_s + ZRT\_s ) \\ xGT\_s = XGT\_s / ( XGT\_s + YGT\_s + ZGT\_s ) \\ yGT\_s = YGT\_s / ( XGT\_s + YGT\_s + ZGT\_s ) \\ xBT\_s = XBT\_s / ( XBT\_s + YBT\_s + ZBT\_s ) \\ yBT\_s = YBT\_s / ( XBT\_s + YBT\_s + ZBT\_s )\end{matrix} \} & ( EXPRESSION 3 )\end{matrix}$$

Hereinafter, processing performed by the microcomputer 43 of the master device Ma in the computation processing K (S125) will be described as an example. In the computation processing K (S125), the microcomputer 43 of the master device Ma substitutes in expression 3 the target brightnesses YRT_α, YGT_α and YBT_α and the target chromaticities xRT_α, xGT_α, xBT_α, yRT_α, yGT_α and yBT_α. Consequently, the microcomputer 43 calculates XRT_α, ZRT_α, XGT_α, ZGT_α, XBT_α and ZBT_α corresponding to the normal mode (group α).

Further, in the computation processing K (S125N), the microcomputer 43 of the slave device Sb in the normal mode calculates XRT_α, ZRT_α, XGT_α, ZGT_α, XBT_α and ZBT_α according to the same manner as in step S125.

Furthermore, in the computation processing K (S125L), the microcomputer 43 of each slave device S in the power saving mode calculates XRT_β, XGT_β, XBT_β and ZBT_β according to the same manner as in step S125.

Video signals (digital video signals) inputted to the video image processing circuit 42 of the projection video image display device 100 are also described as video signals Ri, Gi and Bi below. The video signals Ri, Gi and Bi are the same as Ri, Gi and Bi in expression 1.

Tristimulus values corresponding to the group α and corresponding to the video signals Ri, Gi and Bi are also described as Xn_α, Yn_α and Zn_α below. Further, tristimulus values corresponding to the group β and corresponding to the video signals Ri, Gi and Bi are also described as Xn_β, Yn_β and Zn_β below.

Further, each of Xn_α and Xn_β is also described as Xn_s below. Furthermore, each of Yn_α and Yn_β is also described as Yn_s below. Still further, each of Zn_α and Zn_β is also described as Zn_s below.

“n” of Xn_s, Yn_s and Zn_s is the same as the above “n” of IRn_α and therefore will not be described in detail again. Further, “s” of Xn_s, Yn_s and Zn_s is the mode identifier α or β.

Meanwhile, Xn_s, Yn_s and Zn_s which are the tristimulus values of the video signals Ri. Gi and Bi are expressed by following expression 4.

$$\begin{matrix}[ Mathematical 4 ] & \\ ( \begin{matrix}Xn\_s \\ Yn\_s \\ Zn\_s\end{matrix} ) = ( \begin{matrix}XR0n\_s & XGR0\_s & XB0n\_s \\ YRT\_s & YGT\_s & YBT\_s \\ ZR0n\_s & ZG0n\_s & ZB0n\_s\end{matrix} ) ( \begin{matrix}Ri \\ Gi \\ Bi\end{matrix} ) & ( EXPRESSION 4 )\end{matrix}$$

Correction coefficients RR, RG, RB, GR, GG, GB, BR, BG and BB of expression 1 corresponding to the group α and corresponding to a number indicated by an ID number are also described as correction coefficients RRn_α, RGn_α, RBn_α, GRn_α, GGn_α, GBn_α, BRn_α, BGn_α and BBn_α, respectively below.

Further, correction coefficients RR, RG, RB, GR, GG, GB, BR, BG, BB corresponding to the group β and corresponding to a number indicated by an ID number are also described as correction coefficients RRn_β, RGn_β, RBn_β, GRn_β, GGn_β, GBn_β, BRn_β, BGn_β and BBn_β, respectively below.

Furthermore, correction coefficients RRn_α, RGn_α, RBn_α, GRn_α, GGn_α. GBn_α, BRn_α, BGn_α and BBn_α, and correction coefficients RRn_β, RGn_β, RBn_β, GRn_β, GGn_β, GBn_β, BRn_β, BGn_β and BBn_β are also described as correction coefficients RRn_s, RGn_s, RBn_s, GRn_s, GGn_s, GBn_s, BRn_s, BGn_s and BBn_s below.

“n” of the correction coefficients RRn_s, RGn_s, RBn_s, GRn_s, GGn_s, GBn_s, BRn_s, BGn_s and BBn_s is the same as the above “n” of IRn_α, and therefore will not be described in detail again. Further, “s” of the correction coefficients of RRn_s, RGn_s, RBn_s, GRn_s, GGn_s, GBn_s, BRn_s, BGn_s and BBn_s is the mode identifier α or β.

Following expression 5 is obtained from above expression 1 in which the correction coefficients RR, RG, RB, GR, GG, GB, BR, BG and BB are replaced with RRn_s, RGn_s, RBn_s, GRn_s, GGn_s, GBn_s, BRn_s, BGn_s and BBn_s, respectively, and expression 4.

$$\begin{matrix}[ Mathematical 5 ] & \\ ( \begin{matrix}XRT\_s & XGT\_s & XBT\_s \\ YRT\_s & YGT\_s & YBT\_s \\ ZRT\_s & ZGT\_s & ZBT\_s\end{matrix} ) = ( \begin{matrix}XR0n\_s & XG0n\_s & XB0n\_s \\ YRT\_s & YGT\_s & YBT\_s \\ ZR0n\_s & ZG0n\_s & ZB0n\_s\end{matrix} ) ( \begin{matrix}RRn\_s & GRn\_s & BRn\_s \\ RGn\_s & GGn\_s & BGn\_s \\ RBn\_s & GBn\_s & BBn\_s\end{matrix} ) & ( EXPRESSION 5 )\end{matrix}$$

Next, the microcomputer 43 of each projection video image display device 100 performs correction coefficient calculation processing (S126, S126N and S126L). That is, the microcomputer 43 of each of the master device Ma and the slave devices Sb, Sc and Sd performs the correction coefficient calculation processing.

In the correction coefficient calculation processing, the microcomputer 43 of each projection video image display device 100 calculates correction coefficients corresponding to a set brightness mode of the projection video image display device 100. The correction coefficients are correction coefficients for correcting a level of a video signal inputted to the projection video image display device 100. Further, the correction coefficients are coefficients for making video image chromaticities of each projection video image display device 100 of the same brightness mode the same. The correction coefficients are the above correction coefficients RRn_s, RGn_s, RBn_s, GRn_s, GGn_s, GBn_s, BRn_s, BGn_s and BBn_s.

A little more specifically, in the correction coefficient calculation processing, the microcomputer 43 of each projection video image display device 100 calculates a correction coefficient corresponding to the set brightness mode based on the target chromaticity corresponding to the set brightness mode of the projection video image display device 100.

More specifically, in the correction coefficient calculation processing, the microcomputer 43 of each projection video image display device 100 substitutes in expression 5 the target brightnesses YRT_s, YGT_s and YBT_s calculated in step S70, XR0n_s, ZR0n_s, XG0n_s, ZG0n_s, XB0n_s and ZB0n_s calculated by the computation processing K and XRT_s, ZRT_s, XGT_s, ZGT_s, XBT_s and ZBT_s calculated by the calculation processing K. Consequently, the microcomputer 43 calculates the correction coefficients RRn_s, RGn_s, RBn_s, GRn_s, GGn_s, GBn_s, BRn_s, BGn_s and BBn_s.

Hereinafter, processing performed by the microcomputer 43 of the master device Ma in the correction coefficient calculation processing (S126) will be described as an example. In the correction coefficient calculation processing (S126), the microcomputer 43 of the master device Ma substitutes in expression 5 the target brightnesses YRT_α, YGT_α and YBT_α, XR0n_α, ZR0n_α, XG0n_α, ZG0n_α, XB0n_α and ZB0n_α and XRT_α ZRT_α XGT_α ZGT_α XBT_α and ZBT_α. Consequently, the microcomputer 43 calculates the correction coefficients RRn_α, RGn_α, RBn_α, GRn_α, GGn_α, GBn_α, BRn_α, BGn_α and BBn_α corresponding to the normal mode (group α).

Further, in the correction coefficient calculation processing (S126N), the microcomputer 43 of the slave device Sb in the normal mode calculates correction coefficients RRn_α, RGn_α, RBn_α, GRn_α, GGn_α, GBn_α, BRn_α, BGn_α and BBn_α according to the same manner as in step S126.

Furthermore, in the correction coefficient calculation processing (S126L), the microcomputer 43 of each slave device S in the power saving mode calculates correction coefficients RRn_β, RGn_β, RBn_β, GRn_β, GGn_β, GBn_β, BRn_β, BGn_β and BBn_β according to the same manner as in step S126.

Next, the microcomputer 43 of each projection video image display device 100 performs chromaticity correction processing (S127, S127N and S127L). That is, the microcomputer 43 of each of the master device Ma and the slave devices Sb, Sc and Sd performs the chromaticity correction processing.

The chromaticity correction processing is processing for making video image chromaticities of each projection video image display device 100 of the same brightness mode the same using the calculated correction coefficients.

Hereinafter, processing performed by the microcomputer 43 of the master device Ma in the chromaticity correction processing (S127) will be described as an example. In the chromaticity correction processing (S127), the microcomputer 43 controls the video image processing circuit 42 such that the video image processing circuit 42 adjusts image quality as described above using the calculated correction coefficients RRn_α, RGn_α, RBn_α, GRn_α, GGn_α, GBn_α, BRn_α, BGn_α and BBn_α.

Further, in the chromaticity correction processing (5127N), the microcomputer 43 of the slave device Sb controls the video image processing circuit 42 according to the same manner as in step S127.

Furthermore, in the chromaticity correction processing (S127L), the microcomputer 43 of each slave device S controls the video image processing circuit 42 according to the same manner as in step S127. Processing of the slave device Sc will be described as an example below.

The microcomputer 43 of the slave device Sc controls the video image processing circuit 42 such that the video image processing circuit 42 adjusts image quality as described above using the calculated correction coefficients RRn_β, RGn_β, RBn_β, GRn_β, GGn_β, GBn_β, BRn_β, BGn_β and BBn_β.

According to the above chromaticity correction processing (S127, S127N and S127L), video image chromaticities of each projection video image display devices 100 of the same brightness mode become the same. That is, according to the chromaticity correction processing (S127, S127N and S127L), it is possible to suppress (prevent) video image chromaticity variations of each projection video image display device 100 of the same brightness mode. Further, steps S102M, S102N and S102L are finished, and the brightness/chromaticity adjustment processing in FIG. 8 is finished.

As described above, according to the present preferred embodiment, the same processing as the processing according to the first preferred embodiment is performed. Consequently, it is possible to suppress brightness variations between the projection video image display devices 100 of the same brightness mode.

Further, according to the present preferred embodiment, the master device Ma calculates a target chromaticity by transmitting and receiving the target chromaticity to and from the slave device S of each group per brightness mode. Furthermore, each projection video image display device 100 calculates correction coefficients for correcting levels of video signals based on the target chromaticity corresponding to the brightness mode of each projection video image display device 100. Still further, in the chromaticity correction processing, processing of making video image chromaticities of the projection video image display devices 100 of the same brightness mode the same using the calculated correction coefficients is performed.

Consequently, it is possible to suppress brightness and chromaticity variations between the projection video image display devices 100 per group. That is, it is possible to suppress brightness and chromaticity variations between the projection video image display devices 100 of the same brightness mode. As a result, it is possible to enhance unity of a video image displayed on the multiscreen display device 1000.

In addition if both of brightness adjustment and chromaticity correction are performed only by correcting levels of video signals, a gradation expression level lowers in each projection video image display device 100.

By contrast with this, in the present preferred embodiment, brightness variations are suppressed by adjusting a control current. Further, chromaticity variations are suppressed by correcting levels of video signals. Consequently, it is possible to reduce that digital expression gradations of video signals displayed on a screen lower. Consequently, the processing according to the present preferred embodiment is effective particularly to display video images such as natural images which use a great number of intermediate gradations.

### Third Preferred Embodiment

Methods of reducing brightness and chromaticity variations of a multiscreen display device 1000 have been described with the first and the second preferred embodiments.

In the present preferred embodiment, processing of solving a failure which occurs when a user using the multiscreen display device 1000 changes a brightness mode of one of projection video image display devices 100 which form the multiscreen display devices 1000 will be described. The failure is a failure that most of brightnesses of the multiscreen display device 1000 change. When this failure occurs, the user feels uncomfortable.

First, processing (operation) which is likely to make the user feel uncomfortable will be described as a comparative example.

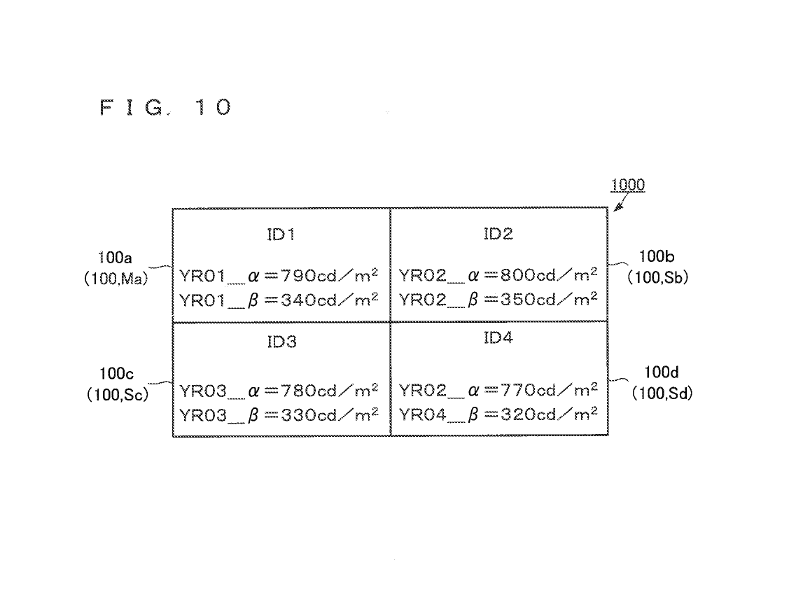

It supposes that the multiscreen display device 1000 is formed with the four projection video image display devices 100 as illustrated in FIG. 10 similar to FIG. 1. Further, each projection video image display device 100 performs one of above steps S31, S32N and S32L in FIG. 5 or 8 such that the microcomputer 43 specifies characteristic brightnesses YR0n_s, YG0n_s and YB0n_s (n=1 to 4 and s=α, β) which the microcomputer 43 can output. In addition, FIG. 10 illustrates only a characteristic brightness corresponding to R for ease of description.

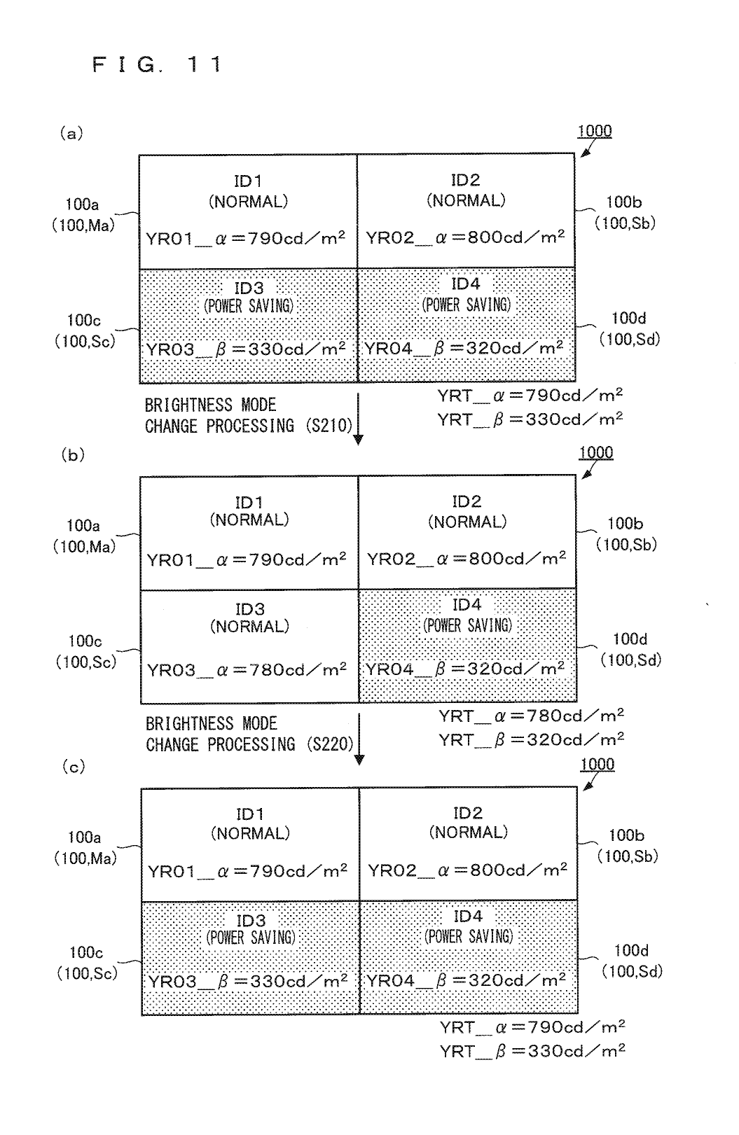

FIG. 11 is a view illustrating a transition of a target brightness when a brightness mode is changed in the comparative example. In addition, FIG. 11 illustrates information for explaining only a characteristic brightness corresponding to R and a target brightness for ease of description.

FIG. 11 illustrates a transition of a target brightness in a following operation stage N. The operation stage N is a stage at which brightness variations are reduced by processing according to the first and second preferred embodiments using a characteristic brightness YR0n_s (n=1 to 4, and s=α, β). More specifically, FIG. 11 illustrates a transition of a target brightness YRT_s (s=α, β) when the user operates an external control device 6 at the operation stage N to change a brightness mode of one of the projection video image display devices 100 which form the multiscreen display device 1000.

Meanwhile, the multiscreen display device 1000 satisfies a following condition B. The condition B is that a normal mode is set as a brightness mode to a master device Ma and a slave device Sb. That is, the master device Ma and the slave device Sb belong to a group α. Further, the condition B is that a power saving mode is set as a brightness mode to slave devices Sc and Sd. That is, the slave devices Sc and Sd belong to a group β.

Part (a) in FIG. 11 illustrates the master device Ma and the slave devices Sb, Sc and Sd under the above condition B. In addition, a target brightness YRT_α corresponding to the normal mode is 790 cd/m². Further, a target brightness YRT_β corresponding to the power saving mode is 330 cd/m².

The reason why the target brightnesses YRT_α and YRT_β take the above values is that the target brightnesses YRT_α and YRT_β are calculated according to processing in step S70 in FIG. 5 or 8 according to the first and second preferred embodiments. More specifically, a characteristic brightness indicating a minimum value among characteristic brightnesses of the master device Ma and the slave device Sb belonging to the group α is calculated as the target brightness for the group α. That is, the target brightness YRT_α is YR01_α according to YRT_α=Min (YR01_α, YR02_α).

Further, a characteristic brightness indicating a maximum value among characteristic brightnesses of the slave devices Sc and Sd belonging to the group β is calculated as the target brightness for the group β. That is, the target brightness YRT_β is YR03_α according to YRT_β=Max(YR03_β, YR04_β).

Next, it is assumed that a user operates the external control device 6 to change a set brightness mode of the slave device Sc from the power saving mode to the normal mode in a state in part (a) in FIG. 11. In this case, the microcomputer 43 of the slave device Sc performs brightness mode change processing (S210) of changing the set brightness mode of the slave device Sc from the power saving mode to the normal mode.

Consequently, the master device Ma and the slave devices Sb, Sc and Sd are placed in a state in part (b) in FIG. 11. That is, devices belonging to the group α are the master device Ma and the slave devices Sb and Sc. In addition, as illustrated in FIG. 10, the characteristic brightness of the slave device Sc in the normal mode is YR03_{—}α=780 cd/m².

In this case, a characteristic brightness indicating a minimum value among the characteristic brightnesses of the master device Ma and the slave devices Sb and Sc belonging to the group α is calculated as the target brightness YRT_α. That is, the target brightness YRT_α becomes YR03_α (780 cd/m²) according to YRT_α=Min(YR0 YR02_α, YR03_α).

Simultaneously, the device belonging to the group β is only the slave device Sd. Hence, the target brightness YRT_β is a characteristic brightness YR04_β (320 cd/m²) of the slave device Sd.

That is, target brightnesses of the projection video image displays 100 belonging to the group α as well as the projection video image display device 100 belonging to the group β are also changed by brightness mode change processing (S210). Consequently, video image brightnesses of all projection video image display devices 100 change. That is, although a brightness mode of one projection video image display device 100 is only changed, the entire brightness of the multiscreen display device 1000 seems to change to the user.

Next, it is assumed that the user operates the external control device 6 to change the set brightness mode of the slave device Sc from the normal mode to the power saving mode in a state in part (b) in FIG. 11. In this case, a microcomputer 43 of the slave device Sc performs brightness mode change processing (S220) of changing the set brightness mode of the slave device Sc from the normal mode to the power saving mode.

Consequently, as illustrated in part (c) in FIG. 11, a group to which each of the master device Ma and the slave devices Sb, Sc and Sd belongs returns to the original group in part (a) in FIG. 11. In this case, when the processing in step S70 is performed, the target brightnesses YRT_α and YRT_β corresponding to each brightness mode become YR01_α (790 cd/m²) and YR03_α (330 cd/m²), respectively.

In the brightness mode change processing (S220), target brightnesses of the projection video image display devices 100 belonging to the group α as well as the projection video image display devices 100 belonging to the group β are changed. Hence, video image brightnesses of all projection video image display devices 100 change. That is, although the brightness mode of one projection video image display device 100 is only changed, the entire brightness of the multiscreen display device 1000 seems to change to the user.

That is, in the comparative example, when the brightness mode change processing (S210) or the brightness mode change processing (S220) is performed, although the brightness mode of one projection video image display device 100 is only changed, the entire brightness of the multiscreen display device 1000 seems to change to the user. Therefore, the user is likely to feel uncomfortable.

Further, in the comparative example, a minimum characteristic brightness indicating a minimum value among the characteristic brightnesses of the projection video image display devices 100 belonging to the group α is calculated as a target brightness as described above. In this case, when the brightness mode of the projection video image display device 100 corresponding to the minimum characteristic brightness is changed, the minimum characteristic brightness of each projection video image display device 100 belonging to the brightness mode before the change changes.

In this regard, when even a target brightness changes, and when the brightness mode of the projection video image display device 100 whose brightness mode is changed becomes the brightness mode before the change, the target brightness changes again. Hence, although the brightness mode of one projection video image display device 100 is only changed, the entire brightness of the multiscreen display device 1000 changes. Hence, the user looking at the multiscreen 10A is likely to feel that a video image is flickering and feel uncomfortable.

Hence, in the present preferred embodiment, when the brightness mode of the projection video image display device 100 is changed, a target brightness corresponding to a brightness mode after the change is calculated according to a following target brightness calculation processing A1. The target brightness calculation processing A1 is executed when the brightness mode of part of a plurality of projection video image display devices which forms the multiscreen display device 1000 is changed. The target brightness calculation processing A1 includes target brightness calculation processing AN and target brightness calculation processing AL.

The target brightness calculation processing AN is processing of calculating a target brightness corresponding to the group α (normal mode). The target brightness calculation processing AL is processing of calculating a target brightness corresponding to the group β (power saving mode). Each of the target brightness calculation processing AN and AL is also referred to simply as the target brightness calculation processing A below.

Meanwhile, the multiscreen display device according to the present preferred embodiment is the multiscreen display device 1000 in FIG. 1.

In addition, a characteristic brightness indicating a minimum value among characteristic brightnesses of the projection video image display devices 100 belonging to the group α is calculated as a target brightness for the group α in step S70 in FIG. 5 according to the first preferred embodiment. Further, a characteristic brightness indicating a maximum value among characteristic brightnesses of the projection video image display devices 100 belonging to the group β is calculated as a target brightness for the group β.

A characteristic brightness indicating a minimum value among characteristic brightnesses of the projection video image display devices 100 belonging to the group α is also referred to as a minimum characteristic brightness below. Further, a characteristic brightness indicating a maximum value among characteristic brightnesses of the projection video image display devices 100 belonging to the group β is also referred to as a maximum characteristic brightness below.

In the target brightness calculation processing A, the minimum characteristic brightness or the maximum characteristic brightness is adopted as a target brightness candidate before the minimum characteristic brightness or the maximum characteristic brightness is adopted as the target brightness whose brightness mode is changed. The brightness mode after the change is also referred to as a changed brightness mode below when the brightness mode of the projection video image display device 100 is changed. Further, a target brightness corresponding to the changed brightness mode is also referred to the changed target brightness below.

The target brightness calculation processing AN and the target brightness calculation processing AL will be more specifically described below. In the target brightness calculation processing A1, each of the target brightness calculation processing AN and the target brightness calculation processing AL is independently performed in parallel.

To sum up, in each of the target brightness calculation processing AN and the target brightness calculation processing AL, the microcomputer 43 of the master device Ma calculates the changed target brightness such that a difference between the target brightness which has already been calculated and the changed target brightness becomes minimum.

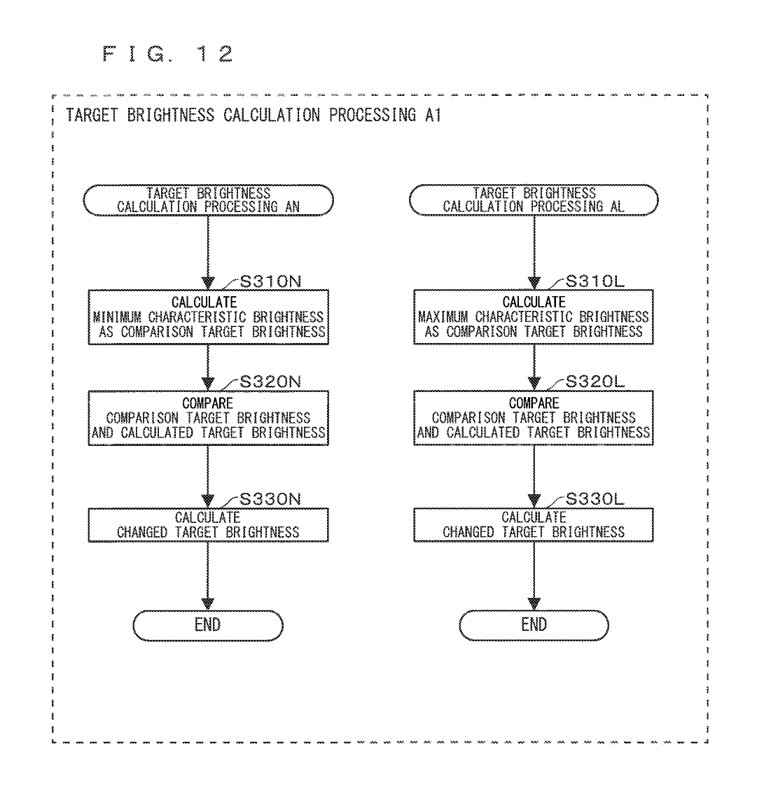

FIG. 12 is a flowchart of the target brightness calculation processing A1. The target brightness calculation processing A1 is performed by the master device Ma. As described above, the target brightness calculation processing A1 includes the target brightness calculation processing AN and the target brightness calculation processing AL. The target brightness which has already been calculated in step S70 in FIG. 5 or FIG. 8 is also referred to as a calculated target brightness below. The calculated target brightness is a latest target brightness of each projection video image display device 100.

Further, calculated target brightnesses corresponding to the group α (normal mode) are also referred to as the calculated target brightnesses α below. The calculated target brightnesses α are YRT_α, YGT_α and YBT_α. Further, calculated target brightnesses corresponding to the group β (power saving mode) are also referred to as the calculated target brightnesses β below. The calculated target brightnesses β are YRT_β, YGT_β and YBT_β.

First, the target brightness calculation processing AN will be described. In the target brightness calculation processing AN, the microcomputer 43 calculates the minimum characteristic brightness as a comparison target brightness (S310N). The comparison target brightness is a brightness used for comparison. Next, the microcomputer 43 compares the comparison target brightness and the calculated target brightness (S320N). Next, the microcomputer 43 calculates as the changed target brightness a target brightness whose value is smaller among the comparison target brightness and the calculated target brightness (S330N).

Next, the target brightness calculation processing AL will be described. In the target brightness calculation processing AL, the microcomputer 43 calculates the maximum characteristic brightness as the comparison target brightness. (S310L). Next, the microcomputer 43 compares the comparison target brightness and the calculated target brightness (S320L). Next, the microcomputer 43 calculates as the changed target brightness a target brightness whose value is higher among the comparison target brightness and the calculated target brightness (S330L).

Next, specific processing of the target brightness calculation processing AN and the target brightness calculation processing AL will be described with reference to an example. Processing of calculating a changed target brightness corresponding to R will be described below for ease for description.

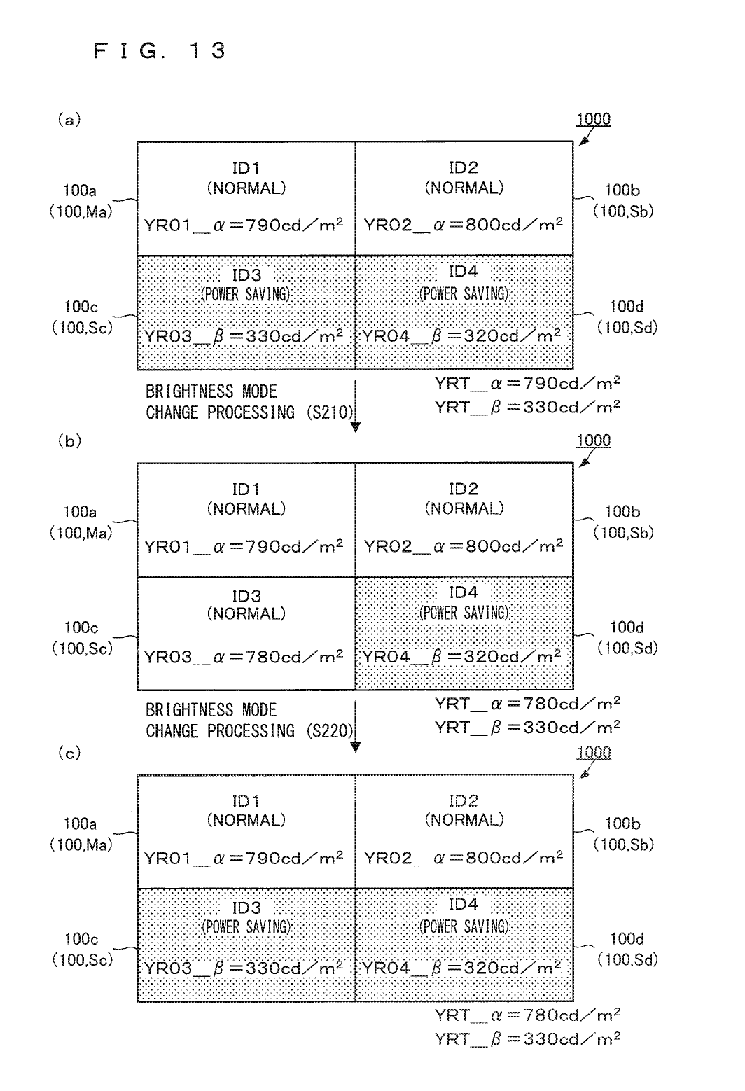

FIG. 13 is a view for explaining target brightness calculation processing according to the third preferred embodiment of the present invention. Further, FIG. 13 illustrates a transition of a target brightness when a brightness mode is changed similar to FIG. 11. In addition, FIG. 13 illustrates information for explaining only a characteristic brightness and a target brightness corresponding to R for ease of description.

More specifically, FIG. 13 illustrates a transition of the target brightness YRT_s (s=α, β) when the user operates the external control device 6 at the above operation stage N to change a brightness mode of one of the projection video image display devices 100 which form the multiscreen display device 1000. In addition, the target brightness is calculated by the target brightness calculation processing AN or the target brightness calculation processing AL.

The multiscreen display device 1000 in part (a) in FIG. 13 employs the same configuration as that of the multiscreen display device 1000 in part (a) in FIG. 11. That is, the multiscreen display device 1000 includes the same brightness mode and the same characteristic brightness as those of the multiscreen display device 1000 in part (a) in FIG. 11.

Next, the user operates the external control device 6 to change the set brightness mode of the slave device Sc from the power saving mode to the normal mode in a state in part (a) in FIG. 13. In this case, the microcomputer 43 of the slave device Sc performs brightness mode change processing (S210) of changing the set brightness mode of the slave device Sc from the power saving mode to the normal mode.

Consequently, the master device Ma and the slave devices Sb, Sc and Sd are placed in the state in part (b) in FIG. 13. That is, devices belonging to the group α are the master device Ma and the slave devices Sb and Sc. In addition, in view of FIG. 10, the characteristic brightness of the slave device Sc in the normal mode is YR03_{—}α=780 cd/m².

Further, the target brightness calculation processing A1 is performed in response to the change of the brightness mode of the slave device Sc. That is, the target brightness calculation processing AN and the target brightness calculation processing AL are performed.

In the target brightness calculation processing AN, the microcomputer 43 first calculates as the comparison target brightness YR03_α (780 cd/m²) which is the minimum characteristic brightness among the characteristic brightnesses of the master device Ma and the slave devices Sb and Sc belonging to the group α (S310N). Next, the microcomputer 43 compares the comparison target brightness (780 cd/m²) and the present calculated target brightness (790 cd/m²) (S320N). Next, the microcomputer 43 calculates as a changed target brightness the comparison target brightness whose value is smaller among the comparison target brightness and the calculated target brightness (S330N).

Simultaneously, a device belonging to the group 3 is only the slave device Sd. Hence, in the target brightness calculation processing AL, the microcomputer 43 first calculates as the comparison target brightness YR04_β (320 cd/m²) which is the maximum characteristic brightness of the characteristic brightness of the slave device Sd belonging to the group β (S310L).

Next, the microcomputer 43 compares the comparison target brightness (320 cd/m²) and the present calculated target brightness (330 cd/m²) (S320L). Next, the microcomputer 43 calculates as the changed target brightness the calculated target brightness whose value is higher among the comparison target brightness and the calculated target brightness (S330L). That is, the present calculated target brightness is maintained as is as the target brightness of the group β (see parts (a) and (b) in FIG. 13).

Further, steps S81, S82N, S82L, S91, S92N, S92L, S93, S94n and S94L in FIG. 5 or 8 are performed using the changed target brightness calculated by the target brightness calculation processing AN and AL as a new target brightness. Consequently, each projection video image display device 100 of the same brightness mode controls a video image brightness according to the changed target brightness.

In this case, unlike the processing in FIG. 11, according to the processing of performing the target brightness calculation processing AN and AL in FIG. 13, the target brightnesses of only the projection video image display devices 100 belonging to the group α are changed. Hence, in the present preferred embodiment, instead of an entire video image brightness of the multiscreen display device 1000 as in the comparative example, video image brightnesses of the master device Ma and the slave devices Sb and Sc change.

Next, it is assumed that the user operates the external control device 6 to change the set brightness mode of the slave device S from the normal mode to the power saving mode in a state in part (b) in FIG. 13(b). In this case, the microcomputer 43 of the slave device Sc performs brightness mode change processing (S220) of changing the set brightness mode of the slave device Sc from the normal mode to the power saving mode.

Consequently, as illustrated in part (c) in FIG. 13, a group belonging to each of the master device Ma and the slave devices Sb, Sc and Sd returns to the original group in part (a) in FIG. 13.

Further, the target brightness calculation processing A1 is performed in response to a change of the brightness mode of the slave device Sc. That is, the target brightness calculation processing AN and the target brightness calculation processing AL are performed.

In the target brightness calculation processing AN, the microcomputer 43 first calculates as the comparison target brightness YR01_α (790 cd/m²) which is the minimum characteristic brightness among the characteristic brightnesses of the master device Ma and the slave device Sb belonging to the group α (S310N).

Next, the microcomputer 43 compares the comparison target brightness (790 cd/m²) and the present calculated target brightness (780 cd/m²) (S320N). Next, the microcomputer 43 calculates as the changed target brightness the calculated target brightness whose value is smaller among the comparison target brightness and the calculated target brightness (S330N). That is, the present calculated target brightness is maintained as is as the target brightness of the group α (see parts (b) and (c) in FIG. 13).

Simultaneously, the slave device Sc is added as a device belonging to the group β. Hence, in the target brightness calculation processing AL, the microcomputer 43 first calculates as the comparison target brightness YR03_β (330 cd/m²) which is the maximum characteristic brightness among the characteristic brightnesses of the slave devices Sc and Sd belonging to the group β (S310L).

Next, the microcomputer 43 compares the comparison target brightness (330 cd/m²) and the present calculated target brightness (330 cd/m²) (S320L). Next, the microcomputer 43 calculates the target brightness (330 cd/m²) whose value is higher among the comparison target brightness and the calculated target brightness as the changed target brightness (S330L). That is, the present calculated target brightness is maintained as is as the target brightness of the group β (see parts (b) and (c) in FIG. 13).

Consequently, in the present preferred embodiment, as described with reference to FIG. 13, except when a video image brightness changes in response to a change of brightness mode actively made by the user, that is, only when the brightness mode change processing (S210) among the brightness mode change processing (S210) and the brightness mode change processing (S220) is performed, video image brightnesses of the master device Ma and the slave devices Sb and Sc change.

In addition, although only R has been described with reference FIG. 13, the same processing is performed to G and B, too.

In the comparative example in FIG. 11, when each of the brightness mode change processing (S210) and the brightness mode change processing (S220) is performed, video image brightnesses of all projection video image display device 100 are changed.

Meanwhile, in the present preferred embodiment, except when a video image brightness changes in response to a change of a brightness mode actively made by the user, that is, only when the target brightness calculation processing AN and the target brightness calculation processing AL are performed and then the brightness mode change processing (S210) is performed, only video image brightnesses of the master device Ma and the slave devices Sb and Sc change.

Hence, according to the present preferred embodiment, when the user performs an operation of changing a brightness mode of one of the projection video image display devices 100, a video image brightness of only a brightness mode (group) whose target brightness needs to be changed is changed. Consequently, it is possible to prevent a video image brightness from changing unnecessarily in response to a change of a brightness mode. As a result, it is possible to prevent the user from feeling uncomfortable.

In addition, a case where a brightness mode of one projection video image display device 100 is changed has been described with the present preferred embodiment. However, the processing according to the present preferred embodiment is applicable to the case where brightness modes of the two or more projection video image display device 100 are changed.

### Other Modified Example

Although the multiscreen display device according to the present invention has been described based on the preferred embodiments above, the present invention is not limited to these preferred embodiments. Modifications one of ordinary skill in the art can conceive and apply to the present preferred embodiment are also incorporated in the present invention within a range which does not deviate from the spirit of the present invention. That is, according to the present invention, each preferred embodiment can be freely combined in the range of the present invention or each preferred embodiment can be adequately modified or omitted.

Further, the projection video image display devices 100 of the multiscreen display device 1000 may not include all components illustrated in FIG. 3. That is, the projection video image display device 100 needs to include only minimum components which can achieve the effect of the present invention.

Further, the present invention may be achieved as a brightness adjusting method including operations of characteristic components of the projection video image display device 100 as steps. Furthermore, according to the present invention, each step included in the brightness adjusting method may be realized by a computer. Still further, the present invention may be realized as a program which causes the computer to execute each step included in such a brightness adjusting method. Moreover, the present invention may be realized as a computer-readable recording medium which stores such a program. Besides, the program may be distributed through a transmission medium such as the Internet.

All numerical values used in the above preferred embodiments are examples of numerical values which are examples for more specifically explaining the present invention. That is, the present invention is not limited to each numerical value used in the above preferred embodiments.

Further, the brightness adjusting method according the present invention corresponds to, for example, brightness/chromaticity adjusting processing in FIG. 5 or brightness/chromaticity adjustment processing in FIG. 8. An order to execute each processing in the brightness adjusting method is an example for more specifically explaining the present invention, and may be an order other than the above order. Further, part of processing of the brightness adjusting method may be executed independently from and in parallel to other processing. In addition, according to the present invention, each preferred embodiment can be freely combined in the range of the present invention or each preferred embodiment can be adequately modified or omitted.

While the invention has been shown and described in detail, the foregoing description is in all aspects illustrative and not restrictive. It is therefore understood that numerous modifications and variations can be devised without departing from the scope of the invention.

What is claimed is:

1. A multiscreen display device which displays a video image on a multiscreen formed with screens of a plurality of projection video image display devices which communicate with each other, wherein
each of said plurality of projection video image display devices includes a light source which emits a light of a brightness corresponding to a current to be supplied, and is formed with a semiconductor light emitting element,
one of a plurality of types of brightness modes of different video image brightnesses which are brightnesses of video images to be displayed by the projection video image display device using a light emitted from said light source is set to each of said projection video image display devices,
each of said plurality of projection video image display devices further includes a storage unit which stores brightness characteristics which are characteristics indicating a relationship between a control current of said light source and said video image brightness as a brightness corresponding to the control current,
a first projection video image display device which is one of said plurality of projection video image display devices includes a calculating unit which calculates a target brightness which is a brightness of a target for each of said brightness modes, based on said video image brightness which said first projection video image display device can output and said video image brightness which a second projection video image display device other than the first projection video image display device of said plurality of projection video image display devices can output, and
each of said projection video display devices
(a) specifies a control current value which is a value of said control current corresponding to said target brightness calculated according to said brightness mode set to the projection video image display device using said brightness characteristics, and which is a target, and
(b) supplies a current indicating said specified control current value, to said light source of the projection video image display device.

2. The multiscreen display device according to claim 1, wherein
each of said projection video image display devices receives an input of a video signal,
the calculating unit further calculates a target chromaticity which is a chromaticity of a target for each of said brightness modes based on a chromaticity corresponding to said control current value specified by said first projection video image display device, said brightness mode set to the first projection video image display device, a chromaticity corresponding to said control current value specified by said second projection video image display device and said brightness mode set to the second projection video image display device, and
each of said projection video image display devices calculates a correction coefficient which corresponds to a set brightness mode and is used to correct a level of said video image signal inputted to the projection video image display device, based on said target chromaticity corresponding to the set brightness mode which is said brightness mode set to the projection video image display device.

3. The multiscreen display device according to claim 1, wherein, when said brightness mode of part of said plurality of projection video image display devices is changed, said calculating unit further calculates a changed target brightness such that a difference between said target brightness which has already been calculated and said changed target brightness which is said target brightness corresponding to said brightness mode after the change becomes minimum.

4. The multiscreen display device according to claim 1, wherein
each of said projection video image display devices communicates with an external computing device, and
said computing device calculates said target brightness on behalf of said calculating unit.
